(19) United States
(12) Patent Application Publication
(10) Pub. No.: US 2011/0139818 A1
(43) Pub. Date: Jun. 16, 2011

(54) CARTRIDGE FOR A DOSING SYSTEM

(76) Inventors: Arnd Kessler, Monheim am Rhein (DE); Salvatore Fileccia, Oberhausen (DE); Hans-Georg Mühlhausen, Dusseldorf (DE); Gerold Jans, Waldburg (DE)

(21) Appl. No.: 13/005,026

(22) Filed: Jan. 12, 2011

Related U.S. Application Data
(63) Continuation of application No. PCT/EP2009/058956, filed on Jul. 14, 2009.

(30) Foreign Application Priority Data
Jul. 15, 2008 (DE) 10 2008 033 238.0

(51) Int. Cl. B67D 7/74

(52) U.S. Cl. 222/129; 222/544

(57) ABSTRACT

A cartridge for flowable washing or cleaning agents for use in a dispenser includes at least two elements, each having a connecting edge by which the at least two elements are connected and bonded together to define an interior space; a plurality of chambers within the interior space for spatially separate accommodation of different preparations of a flowable washing or cleaning agent; a cartridge bottom surface which in a service position is directed downwards in the direction of gravity; and at least two chambers, each of which comprises at least one outlet orifice arranged on the cartridge bottom, wherein the connecting edge of the elements extends across the cartridge bottom surface at a distance from the outlet orifices such that the connecting edge does not intersect with or come into contact with the outlet orifices.

### CROSS-REFERENCES TO RELATED APPLICATIONS

This is a continuation of International Application No. PCT/EP2009/058956, filed Jul. 14, 2009, which claims priority to German Patent Application No. DE 10 2008 033 238.0, filed Jul. 15, 2008, both of which are hereby incorporated by reference.

### FIELD OF THE INVENTION

The invention relates to a cartridge for a dispensing system and to a dispensing system for releasing a plurality of preparations for use in water-conveying appliances, and more particularly relates to water-conveying domestic appliances such as for example dishwashing machines, washing machines, washer/dryers or automatic surface cleaning systems.

### BACKGROUND OF THE INVENTION

Dishwashing agents are available to consumers in numerous presentations. In addition to traditional liquid manual dishwashing agents, automatic dishwashing agents have in particular become increasingly significant as domestic dishwashing machines have become more common. These automatic dishwashing agents are typically offered for sale to the consumer in solid form, for example as a powder or as tablets, but increasingly also in liquid form. For some considerable time, attention has focused on convenient dispensing of washing and cleaning agents and on simplifying the operations required to carry out a washing or cleaning method.

Furthermore, one of the main objectives of manufacturers of automatic cleaning agents is to improve the cleaning performance of these agents, increasing attention having been paid in recent times to cleaning performance in low temperature cleaning cycles or in cleaning cycles with reduced water consumption. To this end, new ingredients, for example more highly active surfactants, polymers, enzymes or bleaching agents have been added to the cleaning agents. However, since new ingredients are only available to a limited extent and the quantity of the ingredients used per cleaning cycle cannot be increased at will for environmental and economic reasons, there are natural limits to this approach to solving the problem.

In this connection, devices for multiple dispensing of washing and cleaning agents have recently in particular come to the attention of product developers. In terms of these devices, a distinction may be drawn between dispensing chambers integrated into the dishwashing machine or washing machine, on the one hand, and separate devices independent of the dishwashing machine or washing machine, on the other hand. These devices, which contain a multiple of the quantity of cleaning agent required to carry out a cleaning method, automatically or semi-automatically dispense washing or cleaning agent portions into the interior of the cleaning machine over the course of a plurality of successive cleaning processes. For the consumer, manual dispensing for each cleaning or washing cycle is no longer necessary. Examples of such devices are described in European patent application EP 1 759 624 A2 (Reckitt Benckiser) or in German patent application DE 53 5005 062 479 A1 (BSH Bosch and Siemens Hausgeräte GmbH).

At present, producing multichamber cartridges, in particular with more than two chambers, in a single part, for example by blow-molding, is associated with considerable technical effort and difficulties. Conventionally, therefore, such cartridges are of multipart construction, wherein the individual elements of the cartridge are molded using injection molding methods and then joined, preferably bonded, together to make a cartridge.

In the case of cartridges which are used in dispensers, the leakproofness of the cartridge orifice in the inserted state is of great significance, since it is necessary to prevent unintentional escape of the preparations stored in the cartridge. This is particularly crucial when the cartridge and the dispenser are operated in a surrounding environment in which temperature and moisture levels fluctuate greatly, such as for example in a dishwashing machine.

Accordingly, it is desirable to provide a cartridge for a dispenser which is couplable in a leakproof manner to a dispenser even when exposed to greatly fluctuating temperature and moisture levels. Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1 is a diagram depicting an autonomous dispenser with a two-chamber cartridge in the separated and assembled states according to an embodiment of the present invention;

FIG. 2 is a perspective view of an autonomous dispenser with two-chamber cartridge arranged in a drawer of a dishwashing machine according to an embodiment of the present invention;

FIG. 3 is a diagram depicting the assembly and integration of an autonomous dispenser into a dishwashing machine according to an embodiment of the present invention;

FIG. 4 is a perspective view of a two-chamber cartridge in the assembled state with an internal dispenser integral with a dishwashing machine according to an embodiment of the present invention;

FIG. 5 is a diagram depicting the assembly and integration of an autonomous dispenser into a dishwashing machine according to an embodiment of the present invention;

FIG. 6 is a partial perspective view of a machine having an integral assembled two-chamber cartridge with an external dispenser according to an embodiment of the present invention;

FIG. 7 is a diagram depicting the assembly and integration of a two-chamber cartridge with an autonomous dispenser into a machine according to an embodiment of the present invention;

FIG. 8 is a partial perspective view of an assembled two-chamber cartridge integrated into a machine according to an embodiment of the present invention;

FIG. 9 is a perspective view of an autonomous dispenser having a refillable two chamber cartridge and a refill unit according to an embodiment of the present invention;

FIG. 10 is a perspective view of a cartridge formed from a trough-shaped and a lid-shaped cartridge element according to an embodiment of the present invention;

FIG. 11 is a perspective view of a cartridge formed from two trough-shaped cartridge elements according to an embodiment of the present invention;

FIG. 12 is a perspective view of a cartridge formed from a cellular, bottomless container and a cartridge bottom according to an embodiment of the present invention;

FIG. 13 is a perspective view of a cartridge formed from a cellular container open at the top, with a cartridge lid according to an embodiment of the present invention;

FIG. 14 is a perspective view of a cartridge formed from two chamber elements according to an embodiment of the present invention;

FIG. 15 is a perspective view of a cartridge with a refill pouch according to an embodiment of the present invention;

FIG. 16 is a perspective view of a cartridge with a chamber for releasing volatile substances according to an embodiment of the present invention;

FIG. 17 is a front view of a cartridge with three chambers according to an embodiment of the present invention;

FIG. 18 is a plan view of a cartridge with three chambers according to an embodiment of the present invention;

FIG. 19 is an exploded view of a two-part cartridge with a trough-shaped and a plate-like cartridge element according to an embodiment of the present invention;

FIG. 20 is an exploded view of a two-part cartridge with a cellular container and a cartridge bottom according to an embodiment of the present invention;

FIG. 21 is an exploded view of a dispenser and cartridge according to an embodiment of the present invention;

FIG. 22 is a front view of a component carrier according to an embodiment of the present invention;

FIG. 23 is a perspective view of a dispenser assembled with a cartridge according to an embodiment of the present invention; and

FIG. 24 is a perspective view of a bracket with a hinge according to an embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

By configuring the cartridge according to the invention, it is possible to achieve improved sealing of a cartridge orifice relative to the dispensing system. The invention additionally enables simple, cost-effective production of the cartridge.

The dispensing system according to the invention consists of the basic components of a cartridge filled with preparation and a dispenser couplable with the cartridge, which is in turn formed of further assemblies, such as for example component carrier, actuator, closing element, sensor, energy source and/or control unit.

It is preferred for the dispensing system according to the invention to be mobile. For the purposes of the present application, mobile means that the dispensing system is not nondetachably connected to a water-conveying device, such as for example a dishwashing machine, washing machine, washer/dryer or the like, but may instead be removed for example from a dishwashing machine by the user or be positioned in a dishwashing machine, i.e. may be handled separately.

According to an alternative development of the invention, it is also conceivable for the dispenser to be connected nondetachably for the user to a water-conveying device such as for example a dishwashing machine, washing machine, washer/dryer or the like and for only the cartridge to be mobile.

In order to ensure operation at elevated temperatures, as may for example occur in individual washing cycles of a dishwashing machine, the dispensing system may be formed from materials which are dimensionally stable up to a temperature of 120° C.

Since, depending on the intended purpose, the preparations to be dispensed may have a pH value of between 2 and 12, any components of the dispensing system which come into contact with the preparations should exhibit appropriate acid and/or alkali resistance. In addition, suitable material selection should ensure that these components are as far as possible chemically inert, for example in relation to nonionic surfactants, enzymes and/or scents.

Cartridge: For the purposes of the present application, a cartridge is understood to be a packaging means which is suitable for enclosing or holding together flowable or sprinklable preparations and is couplable to a dispenser for release of the preparation.

In the simplest conceivable embodiment, the cartridge comprises a preferably dimensionally stable chamber for storing a preparation. In particular, a cartridge may also comprise a plurality of chambers which may be filled with different compositions.

It is advantageous for the cartridge to comprise at least one outlet orifice which is arranged such that gravity-actuated release of preparation from the container may be brought about in the service position of the dispenser. In this way, no further conveying means are required for release of preparation from the container, whereby the structure of the dispenser may be kept simple and manufacturing costs low.

In a preferred development of the invention, at least one second chamber is provided for accommodating at least one second flowable or sprinklable preparation, the second chamber comprising at least one outlet orifice which is arranged such that gravity-actuated product release from the second chamber is brought about in the service position of the dispenser. The arrangement of a second chamber is particularly advantageous when preparations are stored in the mutually separate containers which are not conventionally stable in storage together, such as for example bleaching agents and enzymes.

It is also conceivable for more than two, in particular three to four chambers to be provided in or on a cartridge. In particular, one of the chambers may be designed to release volatile preparations such as for instance a scent into the surrounding environment.

In a further development of the invention the cartridge is of single-part construction. In this way, the cartridges may be produced inexpensively in a single production step, in particular by suitable blow molding methods. The chambers of a cartridge may in this case be separated from one another for example by webs or material bridges, which are formed during or after blow molding.

The cartridge may also be of multi-part construction, being made of components which are produced by injection molding and then assembled.

In addition it is conceivable for the cartridge to be of multi-part construction such that at least one chamber, preferably all the chambers, may be individually removed from or inserted into the dispenser. This makes it possible to replace an already empty chamber, if particularly heavy use is made of a preparation from one chamber, while the others, which may still be full of preparation, remain in the dispenser. In this way, the individual chambers or their preparations may be replenished in a targeted manner appropriate to the circumstances. It is additionally conceivable to construct the individual chambers in such a way that the chambers may only be coupled together or with the dispenser in a specific position or place, so preventing a user from connecting a chamber with the dispenser in a position not intended for said chamber. To this end, the chamber walls may in particular be formed in such a way that they may be connected together interlockingly. It is particularly advantageous, in the case of a cartridge formed of at least three chambers, to form the cartridges such that the chambers may only be connected together interlockingly in a given defined position relative to one another.

The chambers of a cartridge may be fixed to one another by suitable connection methods, such that a container unit is produced. The chambers may be detachably or nondetachably fixed to one another by a suitable interlocking, frictional or bonded connection. In particular, fixing may be effected by one or more of the connection types from the group of snap-in connections, hook-and-loop connections, press connections, melt connections, adhesive connections, welded connections, brazed connections, screw connections, keyed connections, clamped connections or rebound connections. In particular, fixing may also be provided by a heat-shrinkable sleeve, which is drawn in the heated state over all or parts of the cartridge and firmly envelops the chambers or the cartridge in the cooled state.

The bottom of the chambers may be inclined in the manner of a funnel towards the release orifice in order to provide advantageous residual emptying characteristics of the chambers. Moreover, the internal wall of a chamber may be constructed by suitable material selection and/or surface finish such that the preparation adheres only slightly to the internal chamber wall. The residual emptying characteristics of a chamber may also be further optimized by this measure.

In particular, the cartridge may also be of asymmetric construction. It is particularly preferred to make the asymmetry of the cartridge such that the cartridge is only couplable with the dispenser in a predefined position, so preventing incorrect operation by the user which would otherwise be possible.

A dispensing chamber may be constructed in or on a chamber upstream of the outlet orifice in the gravity-actuated direction of flow of the preparation. The dispensing chamber determines the quantity of preparation which, on release of preparation from the chamber, is to be released into the surrounding environment. This is particularly advantageous if the closing element of the dispenser, which effects release of the preparation from a chamber into the surrounding environment, may only be put in a release state and a closed state without the quantity released being measured or monitored. The dispensing chamber then ensures that a predefined quantity of preparation is released without direct feedback of the quantity of preparation being released. The dispensing chambers may be of single-part or multi-part construction. It is furthermore possible to make the dispensing chambers firmly connected to or detachable from the cartridge. In the case of a dispensing chamber detachably connected to the cartridge, it is straightforwardly possible to connect dispensing chambers having different dispensing volumes with a cartridge or to interchange the latter, whereby it is straightforwardly possible to adapt the dispensing volumes to the particular preparation stored in a chamber and it is thus straightforwardly possible to make up the cartridge for different preparations and for dispensing them.

According to another advantageous further development of the invention, one or more chambers in each case comprise(s), in addition to an outlet orifice preferably located at the bottom, a second chamber orifice which is closable in liquid-tight manner and preferably located at the top. This chamber orifice makes it possible, for example, to replenish the preparation stored in the chamber.

The cartridge chambers may be ventilated, in particular in the top zone of the cartridge, by providing ventilation means to ensure pressure equalization between the interior of the cartridge chambers and the surrounding environment as the filling level declines. These ventilation means may, for example, take the form of a valve, in particular a silicone valve, microorifices in the wall of a chamber or cartridge, or the like.

If, according to a further development, the cartridge chambers are not directly ventilated, but instead via the dispenser, or no ventilation is provided, for example when using flexible containers, such as for example pouches, this has the advantage that at elevated temperatures a pressure is developed over the course of a washing cycle of a dishwasher due to heating of the chamber contents, which pressure presses the preparations to be dispensed in the direction of the outlet orifices, such that in this way good residual emptying characteristics of the cartridge may be achieved. Furthermore, in such air-free packaging, there is no risk of substances of the preparation being oxidized, which makes pouch packaging or also bag-in-bottle packaging particularly convenient for oxidation-sensitive preparations.

The volume ratio of the structural volume of the dispenser and the capacity of the cartridge preferably amounts to <1, particularly preferably <0.1, particularly preferably <0.05. In this way it is ensured that, in the case of a predetermined overall structural volume of dispenser and cartridge, the predominant proportion of the structural volume is occupied by the cartridge and the preparation contained therein.

The cartridge may be of any desired three-dimensional shape. It may for example be cubic, spherical or plate-like in form.

The cartridge and the dispenser may in particular be constructed with regard to their three-dimensional shape such that they bring about the slightest possible loss of useful volume in particular in a dishwashing machine.

When using the dispenser in dishwashing machines, it is particularly advantageous to shape the device on the basis of the dishes to be cleaned in dishwashing machines. It may, for example, be plate-shaped, approximately assuming the dimensions of a plate. In this way, the dispenser may be positioned in space-saving manner for example in the lower basket of the dishwasher. Furthermore, the correct positioning of the dispensing unit is immediately obvious to the user thanks to the plate-like shape.

In the coupled state, the dispenser and cartridge preferably have a ratio of height:width:depth of between 5:5:1 and 50:50:1, particularly preferably of around 10:10:1. Due to the “slender” construction of the dispenser and the cartridge it is in particular possible to position the device in the lower basket of a dishwashing machine in the receptacles provided for plates. This has the advantage that the preparations released from the dispenser pass directly into the washing liquor and cannot adhere to other items being washed.

Conventional commercial domestic dishwashing machines are usually designed such that larger items to be washed, such as for instance pans or large plates, are arranged in the lower basket of the dishwashing machine. In order to prevent the user from positioning the dispensing system less than ideally in the upper basket, in an advantageous development of the invention the dispensing system is dimensioned such that the dispensing system may only be positioned in the receptacles provided for this purpose in the lower basket. To this end, the width and height of the dispensing system may in particular be selected between 150 mm and 300 mm, particularly preferably between 175 mm and 250 mm.

It is, however, also conceivable to construct the dispensing unit in a cup shape with a substantially circular or square base area.

The outlet orifices of a cartridge are preferably arranged in a line, so making a slender, plate-shaped configuration of the dispenser possible.

In the case of a cup or pot shaped construction of the cartridge or a cup or pot shaped grouping thereof, it may however also be advantageous to arrange the release orifices of the cartridge for example in an arc shape.

In order to provide direct visual checking of filling level, it is advantageous to form the cartridge at least in portions of a transparent material.

In order to protect heat-sensitive components of a preparation present in a cartridge from exposure to heat, it is advantageous to produce the cartridge from a material with low thermal conductivity.

Another option for reducing the influence of heat on a preparation in a cartridge chamber is to insulate the chamber by suitable measures, for example by using thermal insulation materials such as for instance Styropor which suitably enclose the chamber or the cartridge entirely or in part.

It is also possible to provide the cartridge or individual chambers completely or in portions with a radiation-reflective coating which is in particular suitable for reflecting thermal radiation.

In the presence of a plurality of chambers, another measure for protecting heat-sensitive substances in a cartridge is the manner in which they are arranged relative to one another.

It is, for example, conceivable for the chamber which contains a heat-sensitive product to be partially or completely enclosed by at least one further chamber filled with a product, the latter product and latter chamber in this configuration acting as thermal insulation for the enclosed chamber. This means that a first chamber which contains a heat-sensitive product is partially or completely enclosed by at least one further chamber filled with a product, such that the heat-sensitive product in the first chamber undergoes a slower rise in temperature when the surrounding environment gets hotter than do the products in the surrounding chambers.

In order to bring about a further improvement in thermal insulation, where more than two chambers are used, the chambers may be arranged one around the other in the manner of a Russian doll, so as to form a multi-layer insulating layer.

In particular, it is advantageous for at least one preparation which is stored in an enclosing chamber to have a thermal conductivity of between 0.01 and 5 W/m*K, preferably of between 0.02 and 2 W/m*k, particularly preferably of between 0.024 and 1 W/m*K.

The cartridge is in particular of dimensionally stable construction. It is, however, also conceivable to configure the cartridge as a flexible packaging means, such as for instance as a tube. It is furthermore also possible to use flexible containers such as pouches, in particular if they are inserted in a substantially dimensionally stable receiving container in accordance with the “bag-in-bottle” principle. By using flexible packaging means, it is no longer necessary, unlike in the case of the above-described dimensionally stable cartridge configurations, to provide a ventilation system for pressure equalization.

In a preferred embodiment of the invention, the cartridge comprises an RFID label which at least contains information about the contents of the cartridge and which is readable by the sensor unit which may in particular be provided in the dispenser or dishwashing machine.

This information may, for example, be used in order to select a dispensing program stored in the control unit. In this way it may be ensured that the ideal dispensing program is always used for a specific preparation. It may also be provided that, in the absence of an RFID label or in the case of an RFID label with an incorrect or defective ID, the dispensing device does not dispense but instead an optical or acoustic signal is produced which notifies the user of the error.

In order to prevent misuse of the cartridge, the cartridges may also comprise structural elements which interact with corresponding elements of the dispenser like a key in a lock, such that for example only cartridges of a particular type are couplable to the dispenser. This development furthermore makes it possible for information about the cartridge coupled to the dispenser to be transferred to the control unit, whereby the dispensing device may be controlled in a manner adapted to the contents of the corresponding container.

The cartridge is in particular constructed to accommodate flowable washing or cleaning agents. Such a cartridge particularly preferably comprises a plurality of chambers for spatially separately accommodating in each case different preparations of a washing or cleaning agent. By way of non-exhaustive example, some possible combinations for filling the chambers with different preparations are listed below:

| | Chamber 1 | Chamber 2 | Chamber 3 | Chamber 4 |
|---|---|---|---|---|
| A | Alkaline cleaning | Enzymatic | — | — |
| | preparation | cleaning | | |
| | | preparation | | |
| B | Alkaline cleaning | Enzymatic | Rinse aid | — |
| | preparation | cleaning | | |
| | | preparation | | |
| C | Alkaline cleaning | Enzymatic | Rinse aid | Scent |
| | preparation | cleaning | | |
| | | preparation | | |
| D | Alkaline cleaning | Enzymatic | Rinse aid | Disinfectant |
| | preparation | cleaning | | preparation |
| | | preparation | | |
| E | Alkaline cleaning | Enzymatic | Rinse aid | Pretreatment |
| | preparation | cleaning | | preparation |
| | | preparation | | |

It is particularly preferred for all preparations to be flowable, since this ensures rapid dissolution of the preparations in the washing liquor of the dishwasher, as a result of which these preparations have a rapid to immediate cleaning or rinsing action, in particular also on the walls of the washing compartment and/or of a light guide of the cartridge and/or of the dispenser.

The cartridge conventionally has a total capacity of <5000 ml, in particular <1000 ml, preferably <500 ml, particularly preferably <250 ml, very particularly preferably <50 ml.

The chambers of a cartridge may be of identical or different capacities. In a configuration with two chambers, the ratio of the chamber volumes is preferably 5:1; in a configuration with three chambers preferably 4:1:1, these configurations in particular being suitable for use in dishwashing machines.

As mentioned above, the cartridge preferably has three chambers. When such a cartridge is used in a dishwashing machine, it is particularly preferred for one chamber to contain an alkaline cleaning preparation, another chamber an enzymatic preparation and a third chamber a rinse aid, the volume ratio of the chambers amounting to approximately 4:1:1.

The chamber containing the alkaline cleaning preparation preferably has the greatest capacity of the chambers present. The chambers which store an enzymatic preparation or a rinse aid preferably have approximately identical capacities.

In a two and/or three chamber configuration of the cartridge, it is in particular possible to store in particular a scent, disinfectant and/or pretreatment preparation in a further chamber arranged detachably on the cartridge or on the dispenser.

The cartridge comprises a cartridge bottom, which in the service position is directed downwards in the direction of gravity and in which, preferably for each chamber, there is provided at least one outlet orifice arranged at the bottom in the direction of gravity. The outlet orifices arranged at the bottom are in particular constructed such that at least one, preferably all of the outlet orifices may be connected in communicating manner with the inlet orifices of the dispenser, such that preparation can flow out of the cartridge via the outlet orifices into the dispenser, preferably under the action of gravity.

It is also conceivable for one or more chambers to comprise an outlet orifice which is not arranged at the bottom in the direction of gravity. This is in particular advantageous when for example a scent is to be released into the surrounding environment of the cartridge.

The cartridge is preferably formed of at least two elements which are bonded together, the connecting edge of the elements at the cartridge bottom extending away from the outlet orifices such that the connecting edge does not intersect with the outlet orifices. This is in particular advantageous because in this way leakage problems in the area of the outlet orifices are avoided on coupling with the dispenser, which problems in particular occur on exposure to the major cyclic fluctuations in temperature which conventionally occur in a dishwasher.

The bonded connection may be produced, for example, by adhesive bonding, welding, brazing, pressing or vulcanization.

It is particularly preferred to connect the cartridge elements together by means of hot plate welding. In hot plate welding, a hot metal plate which contains the outline of the boundary surfaces to be connected is used to heat the boundary surface and briefly convert them into a plastic state, such that once the hot plate has been removed and the parts assembled, said plastic zones in melt form resolidify and create a solid connection.

In addition to the hot plate welding method known from the prior art, individually injection molded parts may for example also be joined together by means of laser welding. In laser welding, one of the two materials which are to be melted at the boundary surface must bear an absorbent in order to absorb the energy of the laser beam and convert it into heat, which then melts the corresponding zone of the material. This is typically achieved with coloring pigments which interact thermally with laser beam introduced into the material. These boundary surfaces to be joined may also be covered if the material located thereabove in the direction of incidence of the laser beam is transparent to the laser beam and exhibits no absorbance.

It is furthermore possible to connect individual cartridge elements by means of ultrasound welding methods or IR welding via electrodes.

It is advantageous for the connecting edge to extend along the top, bottom and side faces of the cartridge. In this way, two cartridge elements may in particular be produced by injection molding, with either both elements being trough-shaped or one element being trough-shaped and the second element lid-like.

In order to form a two- or multi-chamber cartridge, at least one of the two cartridge elements may comprise at least one separating web which, in the assembled state of the elements, in each case separates two adjacent chambers of the cartridge from one another.

As an alternative to forming the cartridge from two shell-shaped cartridge elements, it is also conceivable for one cartridge element to be a cellular container with at least one chamber and the second element to be the cartridge bottom or top which is connected in liquid-tight manner along the connecting edge with the cellular container.

It is, of course, also conceivable to combine the above-mentioned cartridge configurations in any desired suitable manner. For example, a two-chamber cartridge may be formed from a trough-like and a lid-like cartridge element and a third single-part or multi-part chamber may be arranged on the top or circumferential surface of the cartridge formed in this manner.

In particular, such a further chamber for accommodating a preparation may be arranged on the cartridge and configured such that volatile substances such as for example scents are released from the preparation into the surrounding environment of the chamber.

According to one development which is to be preferred, the outlet orifices of the cartridge are closed by closing means at least when the cartridge is in the filled, unopened state. The closing means may be constructed such that they permit one-off opening of the outlet orifice by destruction of the closing means. Such closing means are for example sealing films/foils or closing caps.

According to one embodiment of the invention which is to be preferred, the outlet orifices are in each case provided with a closure which, when in the state coupled with a dispenser, permits outflow of preparation from the respective chambers and, when in the uncoupled state of the cartridge, substantially prevents outflow of preparation. The closure in particular takes the form of a silicone slit valve.

It is furthermore preferred for the ventilation orifices of the cartridge to be closed with a closing element before it is first coupled with the dispenser. The closing element may in particular be a stopper or cap which is opened, for example pierced, by the coupling process when it is first coupled with the dispenser.

Before the cartridge is first coupled with the dispenser, it is very particularly preferred for all outlet orifices of the cartridge to be closed with a silicone slit valve and all ventilation orifices with a cap.

The cartridge elements forming the cartridge are preferably formed of a plastics material and may be shaped in a common injection molding process, it possibly being advantageous to form a connecting web acting as a hinge between the two elements, such that, after forming, the two elements are folded over to lie one on the other and are bonded along the connecting edge.

In a further development of the invention, an energy source, in particular a battery or storage battery, is arranged on or in the cartridge, preferably on or in the bottom of the cartridge. Means for coupling the energy source electrically with the dispenser may furthermore be provided on the cartridge.

In a further, preferred development of the invention the cartridge for coupling with a dispenser positionable in the interior of a domestic appliance for releasing at least one washing and/or cleaning agent preparation comprises at least one chamber for storing at least one flowable or pourable washing and/or cleaning agent preparation, wherein, in the state coupled with the dispenser, the cartridge is protected from ingress of washing water into the chamber(s) and the cartridge comprises at least one release orifice at the bottom in the direction of gravity for the, in particular gravity-actuated, release of preparation from at least one chamber and at least one ventilation orifice at the bottom in the direction of gravity for the ventilation of at least one chamber, wherein the ventilation orifice is separate from the release orifice and the ventilation orifice is connected in communicating manner with at least one cartridge chamber.

It is particularly preferred for the cartridge to comprise at least two chambers, very particularly preferably at least three chambers. It is here advantageous for in each case a ventilation orifice and a release orifice to be provided for each chamber.

It is furthermore preferred for the ventilation orifice at the bottom to be connected in communicating manner with a ventilation channel, the end of which remote from the ventilation orifice opens, in the release position of the cartridge coupled with the dispenser, above the maximum filling level of the cartridge.

In this connection, it is advantageous for the ventilation channel entirely or in part to be formed in or on the walls and/or webs of the cartridge. In particular, the ventilation channel may be formed integrally in or on the walls and/or webs of the cartridge.

To this end, the ventilation channel may advantageously be shaped by joining together at least two elements which form the cartridge. For example, a ventilation channel may be formed by joining a separating web of the cartridge formed in the shell-shaped element with two webs bordering the separating web and arranged on the cartridge element.

It is here advantageous for the ventilation channel to be formed by bonded joining, in particular by welding, of a separating web of the cartridge formed in the shell-shaped element with two webs bordering the separating web and arranged on the cartridge element.

Alternatively, the ventilation channel may also take the form, for example, of a dip tube.

In order to ensure cartridge ventilation also in an inclined position, for example when the dispenser is placed in the plate receptacle, it is advantageous for the cartridge filling level (F) in the unopened, filled state of the cartridge not to reach the ventilation channel mouth (83) in an inclined position of up to 45°.

It is moreover advantageous in this connection to arrange the ventilation channel mouth approximately centrally on or in the chamber wall of the cartridge top.

In order to ensure functionality for example also after the cartridge has been in a horizontal position, it is advantageous to configure the viscosity of a flowable preparation and the ventilation channel in such a manner that the preparation is not drawn into the ventilation channel by capillary forces when the preparation reaches the ventilation channel mouth.

Coupling of the cartridge with the dispenser should advantageously be configured such that a pin is arranged on the dispenser, which pin is connected in communicating manner with the inlet orifice of the dispenser and interacts with the couplable cartridge or cartridge chamber in such a manner that, on coupling of the ventilation orifice of cartridge or cartridge chamber with the dispenser, the pin displaces a volume Δv in the ventilation channel, whereby a pressure Δp is produced in the ventilation channel which is suitable for conveying the flowable preparation located in the ventilation channel into the chamber which is connected to the ventilation channel and stores the preparation.

It is preferred for the ventilation orifice of a chamber to be connected in communicating manner with the pin on the dispenser before the closed outlet orifice of the corresponding chamber is opened, for example by a communicating connection with the inlet orifice of the dispenser.

According to a further, advantageous embodiment of the invention, a ventilation chamber is arranged between the ventilation orifice and the ventilation channel.

The cartridge may be configured such that it may be arranged detachably or fixedly in or on the dispenser and/or a dishwashing or washing machine and/or washer/dryer.

In a further, advantageous embodiment of the invention the dispenser for releasing at least one flowable washing and/or cleaning agent preparation into the interior of a domestic appliance comprises a cartridge couplable with the dispenser wherein the cartridge stores at least one flowable washing and/or cleaning agent preparation and the cartridge comprises at least one outlet orifice at the bottom in the direction of gravity, which outlet orifice in the state coupled with the dispenser is connected in communicating manner to an inlet orifice of the dispenser, wherein the dispenser and the cartridge comprise means which interact in such a manner that detachable latching may be established between the dispenser and cartridge, wherein, in the latched state, the dispenser and the cartridge are swivelable relative to one another about a swivel point (SP), and that the outlet orifice of the cartridge and the inlet orifice of the dispensing bracket are configured such that, once latching has been established between the cartridge and dispenser by swiveling the cartridge into the coupled state between the dispensing bracket and cartridge, they are connected in communicating manner.

In particular, it is preferred for the outlet orifices of the chambers and the inlet orifices of the dispenser to be arranged and configured in such a manner that they are connected to one another sequentially by swiveling the dispenser and cartridge in the latched state into the coupled state.

According to a further advantageous embodiment, means may be provided on the dispenser and/or cartridge which, in the coupled state of dispenser and cartridge, bring about detachable fixing of the cartridge to the dispenser.

It is also advantageous to provide means on the dispenser and/or cartridge which, in the latched state of cartridge and dispenser, guide the cartridge during swiveling of the cartridge and dispenser into the coupled state. This may be achieved, for example, by a collar extending around the bottom of the cartridge, which collar is slightly set back relative to a corresponding collar on the dispenser, such that the collar on the cartridge is guided within the collar on the dispenser.

In particular, it is advantageous for the outlet orifices of the chambers to be arranged one behind the other in the swiveling direction. It is very particularly preferred for the outlet orifices of the chambers to be arranged in a line (L) in the swiveling direction.

It is furthermore advantageous for the outlet orifices of the chambers to be approximately identically spaced apart.

In a further, advantageous development of the invention the greatest distance of a chamber outlet orifice from the swivel point (SP) of the cartridge is approximately 0.5 times the cartridge width (B).

In particular, at least two of the cartridge chambers may have different volumes.

Advantageously, the cartridge chamber with the greatest volume is furthest from the swivel point (SP) of the cartridge 1.

In a further development of the invention, the ventilation orifice of a chamber is in each case located upstream of a chamber outlet orifice in the swiveling direction during coupling of the cartridge with the dispenser.

The ratio of cartridge depth (T) to cartridge width (B) is preferably approximately 1:20. The ratio of cartridge height (H) to cartridge width (B) preferably amounts to approximately 1:1.2.

It is likewise preferred for the ventilation orifice of a chamber in each case to be located upstream of a chamber outlet orifice in the swiveling direction during coupling of the cartridge with the dispenser.

Light guide, cartridge: In a preferred embodiment of the invention, the cartridge for coupling with a dispenser for releasing at least one washing and/or cleaning agent preparation from the cartridge into the interior of a domestic appliance comprises a light guide arranged in or on the cartridge, into which light guide a light signal may be incoupled from outside the cartridge.

It is particularly preferred to incouple a light signal which is emitted from the dispenser into the cartridge.

The light guide may in particular be formed entirely or in part in or on the walls and/or webs of the cartridge.

It is furthermore advantageous to provide the light guide integrally in or on the walls and/or webs of the cartridge.

The light guide preferably consists of a transparent plastics material. It is, however, also possible to make the entire cartridge from a transparent material.

It is preferred for the light guide to be suitable to conduct light in the visible range (380-780 nm). It is particularly preferable for the light guide to be suitable to conduct light in the near infrared range (780 nm-3000 nm). In particular, it is preferred for the light guide to be suitable to conduct light in the mid infrared range (3.0 μm-50 μm).

The light guide in particular consists of a transparent plastics material with an elevated refractive index.

Advantageously, the light guide is entirely or partially enclosed at least in portions by a material with a lower optical refractive index. In particular, the material of the lower optical refractive index may be a preparation stored in a cartridge chamber.

A ratio of the refractive indices of the preparation and light guide of 1:1.10-1:5, preferably of 1:1.15-1:1.35, particularly preferably of 1:1.15-1:1.20 has proved particularly advantageous, the refractive index in each case being determined at a wavelength of 589 nm. The refractive index of the light guide may for example be determined to DIN EN ISO 489. The refractive index of the preparation may be determined by means of a Abbe refractometer to DIN 53491.

It is in particular advantageous for the preparation which entirely or partially encloses the light guide to have a transmittance of 45%-95%, particularly preferably of 60%-90%, very particularly preferably of 75%-85%. The light guide preferably has a transmittance of >75%, very particularly preferably of >85%. Transmittance may be determined to DIN 5036.

It is furthermore preferred for the wavelength of the light which is transmitted through the light guide approximately to correspond to the wavelength of at least one preparation which encloses the light guide at least in portions, which is not absorbed from the visible spectrum by the preparation. It is here particularly preferred for the wavelength of the light which is transmitted through the light guide and the wavelength which is not absorbed by the preparation to be between 600-800 nm.

The light signal incouplable into the light guide in particular bears information, in particular for example with regard to the operating state of the dispenser and/or the filling level of the cartridge.

In a further development of the invention which is to be preferred, the light guide is constructed such that the light signal incouplable into the light guide is also outcouplable again from the light guide.

It may here be advantageous for the light guide to be constructed such that the light signal is outcouplable at a point on the cartridge which is different from the point at which the light signal may be incoupled into the cartridge.

Incoupling and outcoupling of the light signal may in particular be carried out at a prismatically constructed edge of the cartridge.

It is particularly preferred to form incoupling or outcoupling points for the light signal in the corresponding injection mold by highly polished or hard chromium plated tool surfaces such that the reflectivity of the incoupling or outcoupling point is low and the desired signal incoupling is possible.

The distance from the light source, in particular an LED, arranged in the dispenser to the light incoupling point into the cartridge in the coupled state of the cartridge and dispenser should be kept as small as possible.

It is also advantageous for the light signal and the light guide to be configured such that a light signal visible to a user may be generated on and/or in the cartridge.

According to a further development, the light guide may be severed at least one point in the cartridge in such a manner that the preparation can fill the discontinuity. In this way, it is straightforwardly possible to provide a filling level and/or inclination sensor, the light signal passing through the discontinuity in the absence of preparation differing from the light signal passing through the discontinuity entirely or partially filled with preparation.

Dispenser: The control unit necessary for operation and at least one actuator are integrated into the dispenser. A sensor unit and/or an energy source is preferably likewise arranged on or in the dispenser.

The dispenser preferably consists of a housing protected from water splashing, which prevents penetration of water splashes, as may for example occur during use in a dishwashing machine, into the interior of the dispenser, in which dispenser are arranged at least the control unit, sensor unit and/or actuator.

It is particularly advantageous to encapsulate in particular the energy source, the control unit and the sensor unit in such a manner that the dispenser is substantially water-tight, i.e. the dispenser is functional even when completely immersed in liquid. Examples of encapsulation materials which may be used are multi-component epoxide and acrylate encapsulation compounds such as methacrylate esters, urethane meth- and cyanoacrylates or two-component materials comprising polyurethanes, silicones, epoxy resins.

An alternative or supplement to encapsulation is enclosing the components in an appropriately designed, moisture-tight housing. Such a development is further explained in greater detail below.

It is furthermore advantageous to arrange the components or assemblies on and/or in a component carrier in the dispenser; this too is further explained elsewhere.

It is furthermore advantageous for the material from which the dispenser is shaped to prevent or at least reduce biofilm growth. This may be achieved by using appropriate surface textures of the material or additives, such as for example biocides, known from the prior art. It is also conceivable to provide some areas of the dispenser at risk of microbial growth, in particular those areas in which washing water can accumulate, with a finish which prevents or at least reduces biofilm growth. Films/foils with an appropriate action may for example be used for this purpose.

It is particularly preferred for the dispenser to comprise at least one first interface which interacts with a corresponding interface provided in or on a domestic appliance, in particular a water-conveying domestic appliance, preferably a dishwashing or washing machine, such that electrical energy and/or signals is/are transmitted from the domestic appliance to the dispenser and/or from the dispenser to the domestic appliance.

In one development of the invention, the interfaces take the form of plug-in connectors. In a further development, the interfaces may be constructed such that electrical energy and/or electrical and/or optical signals are transmitted wirelessly.

It is here particularly preferred for the interfaces provided for transmitting electrical energy to be inductive transmitters and receivers of electromagnetic waves. The interface of a water-conveying appliance, such as for instance a dishwashing machine, may accordingly in particular be configured as an AC-operated transmitter coil with an iron core and the dispenser interface may be configured as a receiver coil with an iron core.

In an alternative embodiment, the transmission of electrical energy may also be provided by means of an interface which comprises, on the domestic appliance side, an electrically operated light source and, on the dispenser side, a light sensor, for example a photodiode or a solar cell. The light emitted by the light source is converted into electricity in the light sensor, which is then in turn stored, for example, by a storage battery on the dispenser side.

In an advantageous further development of the invention, an interface is provided on the dispenser and the water-conveying appliance, such as for instance a dishwashing machine, for transferring (i.e. transmitting and receiving) electromagnetic and/or optical signals, which in particular represent operating state, measurement and/or control information of the dispenser and/or of the water-conveying equipment such as a dishwashing machine.

It is, of course, possible only to provide an interface for transmitting signals or an interface for transmitting electrical energy or in each case to provide an interface for transmitting signals and an interface for transmitting electrical energy or to provide an interface with is suitable for transmitting both electrical energy and signals.

Such an interface may in particular be constructed such that electrical energy and/or electromagnetic and/or optical signals is/are transmitted wirelessly.

It is particularly preferred for the interface to be configured for emitting and/or receiving optical signals. It is very particularly preferred for the interface to be configured to emit or receive light in the visible range. Since conventionally when a dishwashing machine is in operation it is dark inside the washing compartment, signals may be emitted and/or detected by the dispenser in the visible optical range, for example in the form of signal pulses or photoflashes. It has proved particularly advantageous to use wavelengths of between 600-800 nm in the visible spectrum.

Alternatively or in addition, it is advantageous for the interface to be configured to emit or receive infrared signals. It is particularly advantageous for the interface to be configured to emit or receive infrared signals in the near infrared range (780 nm-3000 nm).

In particular, the interface comprises at least one LED. Particularly preferably, the interface comprises at least two LEDs. It is also possible according to a further preferred development of the invention to provide at least two LEDs, which emit light at different wavelengths. This makes it possible, for example, to define different signal bands on which information may respectively be transmitted or received.

In addition, it is advantageous, in a further development of the invention, for at least one LED to be an RGB LED, the wavelength of which is adjustable. Thus, for example, different signal bands which emit signals on different wavelengths may be defined with one LED. It is thus for example also conceivable for light to be emitted on a different wavelength during the drying process, during which high atmospheric humidity (fog) prevails in the washing compartment, than for example during a washing stage.

The interface of the dispenser may be configured in such a way that the LED is provided both for emitting signals inside the dishwasher, in particular when the dishwashing machine door is closed, and for optical display of an operating state, in particular when the dishwashing machine door is open.

It is particularly preferable for an optical signal to be configured as a signal pulse with a pulse duration of between 1 ms and 10 seconds, preferably between 5 ms and 100 ms.

In addition, it is advantageous for the interface of the dispenser to be configured in such a way that it emits an optical signal with the dishwashing machine closed and unloaded which brings about an average illuminance E of between 0.01 and 100 lux, preferably between 0.1 and 50 lux, measured at the walls bounding the washing compartment. This illuminance is then sufficient to bring about multiple reflections with or at the other washing compartment walls and thus to reduce or prevent possible signal shadows in the washing compartment, in particular when the dishwashing machine is loaded.

The signal emitted and/or received by the interface in particular bears information, in particular being a control signal or a signal which represents an operating state of the dispenser and/or of the dishwasher.

In an advantageous further development of the invention, the dispenser for releasing at least one washing and/or cleaning agent preparation from a cartridge into the interior of a domestic appliance comprises a light source, by means of which a light signal may be incoupled into a light guide of the cartridge. The light source may in particular be an LED. This for example makes it possible to incouple light signals, for example representing the operating state of the dispenser, from the dispenser into the cartridge, such that said signals are visually perceptible on the cartridge by a user. This is in particular advantageous because, in the service position in the plate receptacle of a crockery drawer in a dishwasher, the dispenser may be visually concealed between other items to be washed. By incoupling the light from dispenser into the cartridge, the corresponding light signals may for example also be guided into the top zone of the cartridge, such that, even if the dispenser is positioned in the plate receptacle between other items to be washed, the light signals are visually perceptible by the user since, if the crockery drawer is properly loaded, the top zones of the items to be washed and of the cartridge conventionally remain uncovered.

It is furthermore possible for the light signal incoupled into and passing through the light guide of the cartridge to be detectable by a sensor located on the dispenser. This is explained in greater detail in the following section.

In a further, advantageous development, the dispenser for releasing at least one washing and/or cleaning agent preparation into the interior of a domestic appliance comprises at least one optical transmit unit, the optical transmit unit being configured such that signals from the transmit unit may be incoupled into a cartridge couplable with the dispenser and signals from the transmit unit may be emitted into the surrounding environment of the dispenser. In this way, it is possible by means of an optical transmit unit to achieve not only signal transmission between the dispenser and for example a domestic appliance such as a dishwashing machine but also signal input into a cartridge.

In particular, the optical transmit unit may be an LED which preferably emits light in the visible and/or IR range. It is also conceivable to use another suitable optical transmit unit, such as for example a laser diode. It is particularly to be preferred to use optical transmit units, which emit light in the wavelength range between 600-800 nm.

In an advantageous further development of the invention the dispenser may comprise at least one optical receive unit. This for example makes it possible for the dispenser to receive signals from an optical transmit unit arranged in the domestic appliance. This may be achieved by any suitable optical receive unit, such as for example photocells, photomultipliers, semiconductor detectors, photodiodes, photoresistors, solar cells, phototransistors, CCD and/or CMOS image sensors. It is particularly preferred for the optical receive unit to be suitable for receiving light in the wavelength range from 600-800 nm.

In particular, the optical receive unit on the dispenser may also be constructed such that the signals from the transmit unit incouplable into a cartridge coupled with the dispenser are outcouplable from the cartridge and are detectable by the optical receive unit of the dispenser.

The signals emitted by the transmit unit into the surrounding environment of the dispenser may preferably represent information with regard to operating states or control commands.

Dispensing chamber: The dispenser for releasing at least one flowable washing and/or cleaning agent preparation into the interior of a domestic appliance may in particular comprise a dispensing chamber which, with the cartridge couplable with the dispenser, is connected in communicating manner with a dispensing chamber inlet located in the dispenser, such that, in the service position of the dispenser, preparation flows in gravity-actuated manner from the cartridge into the dispensing chamber wherein a dispensing chamber outlet is arranged downstream in the direction of gravity from the dispensing chamber inlet, which dispensing chamber outlet is closable by a valve, wherein a float is arranged in the dispensing chamber, the density of which is lower than the density of the preparation, wherein the float is constructed such that preparation may flow around and/or through the float and the float and the dispensing chamber inlet are configured such that the dispensing chamber inlet is closable by the float.

Depending on the configuration of the density of the preparation and the density of the float and the resultant buoyancy, the float may close the dispensing chamber inlet in sealing or nonsealing manner. In the case of a nonsealing closure, while the float does indeed rest against the dispensing chamber inlet, it does not seal the latter with regard to inflow of preparation from the cartridge, such that an exchange of preparation between the cartridge and the dispensing chamber is possible. In this development of the invention, the float acts as a deliberate throttle which, on opening of the valve, minimizes slippage between the dispensing chamber inlet and dispensing chamber outlet and so contributes to determining dispensing accuracy.

Alternatively, the float and the dispensing chamber may be constructed as a self-closing valve, on the one hand, to ensure the lowest possible energy consumption in a dispenser autonomous with regard to energy; on the other hand a defined quantity of preparation which approximately corresponds to the capacity of the dispensing chamber is released.

It is particularly advantageous to select the density of the washing and/or cleaning agent preparation and the density of the float such that the float exhibits a rate of ascent in the washing and/or cleaning agent preparation of 1.5 mm/sec to 25 mm/sec, preferably of 2 mm/sec to 20 mm/sec, particularly preferably of 2.5 mm/sec to 17.5 mm/sec. This ensures sufficiently rapid closure of the dispensing chamber inlet by the ascending float and thus a sufficiently short interval between two instances of dispensing preparation.

The rate of ascent of the float may advantageously also be stored in the valve-actuating control unit of the dispenser. In this way, it is also possible to control the valve in such a manner that a volume of preparation is released which is greater than the volume of the dispensing chamber. In this case, the valve is then reopened before the float reaches its upper closure position against the dispensing chamber inlet and closes the dispensing chamber inlet.

In order to ensure accurate dispensing from the dispensing chamber into the surrounding environment of the dispenser, it has proved advantageous for the float and the dispensing chamber to be configured such that, in the release position of the valve assigned to the dispensing chamber outlet, the rate of ascent of the float in the washing and/or cleaning agent preparation is lower than the rate of flow of the preparation surrounding the float out of the dispensing chamber.

It is preferred to make the float substantially spherical. Alternatively, the float may also be substantially cylindrical.

It is preferable for the dispensing chamber to be substantially cylindrical. It is furthermore advantageous for the diameter of the dispensing chamber to be slightly larger than the diameter of the cylindrical or spherical float, such that slippage with regard to the preparation arises between the dispensing chamber and the float.

According to a development which is to be preferred, the float is formed from a foamed, polymeric material, in particular from foamed PP.

In a further, preferred embodiment, the dispensing chamber is made L-shaped.

Furthermore, a diaphragm may be arranged in the dispensing chamber between the dispensing chamber inlet and dispensing chamber outlet, wherein the diaphragm orifice is constructed such that it may be closed by the float in sealing or nonsealing manner, wherein the float is preferably arranged between the diaphragm and the dispensing chamber inlet.

Component carrier: The dispenser comprises a component carrier on which are arranged at least the actuator and the closing element and the energy source and/or the control unit and/or the sensor unit and/or the dispensing chamber.

The component carrier comprises receptacles for the stated components and/or the components are shaped in a single part with the component carrier.

The receptacles for the components in the component carrier may be provided for a frictional, interlocking and/or bonded connection between a corresponding component and the corresponding receptacle.

For the purposes of simple demounting of the components from the component carrier, it is furthermore conceivable for the dispensing chamber, the actuator, the closing element, the energy source, the control unit and/or the sensor unit in each case to be detachably arranged on the component carrier.

It is also advantageous for the energy source, the control unit and the sensor unit to be arranged as a combined assembly on or in the component carrier.

In an advantageous further development of the invention, the energy source, the control unit and the sensor unit are combined as an assembly. This may for example be achieved by arranging the energy source, the control unit and the sensor unit on a common electrical printed circuit board.

According to a further preferred development of the invention, the component carrier is of a trough-like design and manufactured as an injection molding. It is particularly preferable for the dispensing chamber to be of single-part construction with the component carrier.

The component carrier ensures maximally straightforward automatic population of the dispenser with the necessary components. The component carrier may in this way be preassembled preferably automatically in its entirety and assembled to form a dispenser.

According to one embodiment of the invention, once populated, the trough-like component carrier may be closed in liquid-tight manner with a, for example, lid-like closing element. The closing element may for example take the form of a film/foil which is bonded in liquid-tight manner with the component carrier and, with the trough-like component carrier, forms one or more liquid-tight chambers.

The closing element may also be a bracket, into which the component carrier may be introduced, wherein, when in the assembled state, the bracket and the component carrier form the dispenser. When in the assembled state, the component carrier and the bracket interact such that a liquid-tight connection is formed between the component carrier and the bracket, such that no washing water can get into the interior of the dispenser or of the component carrier.

In the service position of the dispenser, it is furthermore preferred for the receptacle for the actuator on the component carrier to be arranged above the dispensing chamber in the direction of gravity, whereby a compact structure of the dispenser may be achieved. The compact design may be further optimized by arranging the dispensing chamber inlet on the component carrier above the receptacle of the actuator in the service position of the dispenser. It is also to be preferred for the components on the component carrier to be arranged substantially in a row relative to one another, in particular along the longitudinal axis of the component carrier.

In a further development of the invention, the receptacle for the actuator comprises an orifice which is in line with the dispensing chamber outlet, such that a closing element may be moved to and fro by the actuator through the orifice and the dispensing chamber outlet.

It is particularly preferred for the component carrier to be formed of a transparent material.

The component carrier advantageously comprises at least one light guide, through which light from the surrounding environment of the dispenser may be guided into and/or out of the interior(s) of the dispenser or of the component carrier to an optical transmit and/or receive unit, wherein the light guide is in particular shaped in a single-part with the transparent component carrier.

It is accordingly furthermore preferred for at least one orifice to be provided in the dispenser, through which the light from the surrounding environment of the dispenser may be incoupled and/or outcoupled into and/or out of the light guide.

Actuator: For the purposes of the present application, an actuator is a device which converts an input variable into an output variable of a different kind and with which an object is moved or movement thereof is brought about, the actuator being coupled with at least one closing element such that release of preparation from at least one cartridge chamber may indirectly or directly be effected.

The actuator may be driven by means of drives selected from the group of gravity drives, ion drives, electric drives, motor drives, hydraulic drives, pneumatic drives, gear drives, worm gear drives, ball-screw drives, linear drives, roller-screw drives, toothed worm drives, piezoelectric drives, chain drives, and/or reaction drives.

In particular, the actuator may be constructed from an electric motor which is coupled with a gear train which converts the rotational motion of the motor into a linear motion of a carriage coupled to the gear train. This is in particular advantageous in a slender, plate-shaped configuration of the dispensing unit.

At least one magnet element may be arranged on the actuator, which magnet element, together with a magnet element of identical polarity on a dispenser, effects product release from the container as soon as the two magnet elements are positioned relative to one another such that magnetic repulsion is brought about by the magnetic elements of identical polarity and a contactless release mechanism is created.

In a particularly preferred embodiment of the invention, the actuator is a bistable solenoid which, together with a closing element taking the form of a plunger core engaging in the bistable solenoid, forms a pulse-controlled bistable valve. Bistable solenoids are electromechanical magnets with a linear direction of motion, the plunger core coming to an unenergized rest in each end position.

Bistable solenoid or valves are known from the prior art. In order to change between valve positions (open/closed), a bistable valve requires a pulse and then remains in this position until a counter-pulse is transmitted to the valve. Such a valve is accordingly also known as a pulse-controlled valve. One substantial advantage of such pulse-controlled valves is that they do not consume any energy in order to remain at the valve end positions, the closure position and the release position, but instead merely require an energy pulse to change valve position and the valve end positions should thus be considered stable. A bistable valve remains in whatever switching position for which it most recently received a control signal.

The closing element (plunger core) is driven to one end position for each pulse of electricity. If the power is switched off, the closing element retains its position. The closing element (plunger core) is driven to the other end position for each pulse of electricity. If the power is switched off, the closing element retains its position.

Bistable characteristics of solenoids may be achieved in various ways. On the one hand, it is known to divide the coil. The coil is divided more or less centrally, so creating a gap. A permanent magnet is inserted into this gap. The plunger core itself has material removed from it by lathe from both front and rear such that, in each end position, it has a planar face relative to the magnet frame. The magnetic field of the permanent magnet flows through this face. The plunger core sticks here. Alternatively, it is also possible to use two separate coils. The principle is similar to the bistable solenoid with a divided coil. The difference is that there actually are two different electrical coils. These are separately driven depending on the direction in which the plunger core is to be moved.

Closing element: A closing element for the purposes of the present application is a component on which the actuator acts and which, as a consequence of said action, brings about opening or closing of an outlet orifice.

The closing element may, for example, comprise valves which may be adjusted by the actuator into a product release position or a closure position.

It is particularly preferred for the closing element and the actuator to assume the form of a solenoid valve, in which the dispenser is embodied by the valve and the actuator by the electromagnetic or piezoelectric drive of the solenoid valve. In particular when a plurality of containers and thus of preparations to be dispensed are used, the use of solenoid valves permits very precise control of the quantity and timing of dispensing.

It is therefore advantageous to control the release of preparations from each outlet orifice of a chamber with a solenoid valve such that the solenoid valve indirectly or directly determines the release of preparation from the product release orifice.

Sensor: For the purposes of the present application, a sensor is a measured variable pickup or detecting element, which may qualitatively or quantitatively detect specific physical or chemical properties and/or the material nature of its surrounding environment as a measured variable.

The dispensing unit preferably comprises at least one sensor, which is suitable for detecting a temperature. The temperature sensor is designed in particular to detect a water temperature.

It is additionally preferred for the dispensing unit to comprise a sensor for detecting conductivity, whereby in particular the presence of water or the spraying of water, in particular in a dishwashing machine, is detected.

In a further development of the invention the dispensing unit comprises a sensor, which may determine physical, chemical and/or mechanical parameters from the surrounding environment of the dispensing unit. The sensor unit may comprise one or more active and/or passive sensors for the qualitative and/or quantitative detection of mechanical, electrical, physical and/or chemical variables which are forwarded to the control unit as control signals.

In particular, the sensors of the sensor unit may be selected from the group of timers, temperature sensors, infrared sensors, brightness sensors, temperature sensors, motion sensors, strain sensors, rotational speed sensors, proximity sensors, flow sensors, color sensors, gas sensors, vibration sensors, pressure sensors, conductivity sensors, turbidity sensors, instantaneous acoustic pressure sensors, “lab-on-a-chip” sensors, force sensors, acceleration sensors, inclination sensors, pH sensors, moisture sensors, magnetic field sensors, RFID sensors, magnetic field sensors, Hall sensors, biochips, odor sensors, hydrogen sulfide sensors and/or MEMS sensors.

In particular in the case of preparations whose viscosity is subject to severe temperature-dependent fluctuation, it is advantageous to provide flow sensors in the dispensing device for monitoring the volume or mass of the dispensed preparations. Suitable flow sensors may be selected from the group of diaphragm flow sensors, magnetic-inductive flow meters, mass flow metering using the Coriolis method, eddy flow metering, ultrasound flow metering, rotameter metering, annular piston flow metering, thermal mass flow metering or differential pressure flow metering.

Control unit: A control unit for the purposes of the present application is a device which is suitable for influencing the transport of material, energy and/or information. To this end, the control unit acts on actuators with the assistance of information, in particular sensor unit measurement signals, which it processes for the purposes of the control objective.

The control unit may in particular comprise a programmable microprocessor. In a particularly preferred embodiment of the invention, a plurality of dispensing programs are stored in the microprocessor which may be selected and executed depending on the container coupled to the dispenser.

In a preferred embodiment, the control unit is not connected to any controller which may be present in the domestic appliance. Accordingly, no information, in particular electrical, optical or electromagnetic signals, is exchanged directly between the control unit and the controller of the domestic appliance.

In an alternative development of the invention the control unit is coupled to the existing controller of the domestic appliance. This coupling is preferably cable-less. It is possible, for example, to position a transmitter on or in a dishwashing machine, preferably on or at the dispensing chamber set into the door of the dishwashing machine, which transmits a signal wirelessly to the dispensing unit if the controller of the domestic appliance brings about dispensing for example of a cleaning agent from the dispensing chamber or of rinse aid.

A plurality of programs for the release of different preparations or for the release of products in different instances of use may be stored in the control unit.

In a preferred development of the invention, the appropriate program is called by corresponding RFID labels or geometric information media formed on the container. It is thus for example possible to use the same control unit for a plurality of applications, for example for dispensing cleaning agents in dishwashing machines, for releasing perfumes for room fragrancing, for applying cleaning substances to a toilet bowl etc.

In order to dispense preparations which in particular have a tendency towards gelation, the control unit may be configured in such a way that on the one hand dispensing takes place in a sufficiently short time to ensure a good cleaning result and on the other hand the preparation is not dispensed so quickly that the spurt of preparation gels. This may be effected for example by release at intervals, the individual dispensing intervals being adjusted in such a way that the correspondingly dispensed quantities dissolve completely during a cleaning cycle.

It is particularly preferable for the dispensing intervals for releasing a preparation to be between 30-90 sec, particularly preferably 45-75 sec.

Release of preparations from dispenser may proceed in sequence or at the same time.

It is particularly preferable to dispense a plurality of preparations in sequence in a washing program. The following dispensing sequences are particularly preferable:

| 1st dispensing | 2nd dispensing | 3rd dispensing | 4th dispensing |
|---|---|---|---|
| Enzymatic | Alkaline cleaning | | |
| cleaning | preparation | | |
| preparation | | | |
| Alkaline cleaning | Rinse aid | | |
| preparation | | | |
| Enzymatic | Alkaline cleaning | Rinse aid | |
| cleaning | preparation | | |
| preparation | | | |
| Enzymatic | Alkaline cleaning | Rinse aid | Disinfectant |
| cleaning | preparation | | preparation |
| preparation | | | |
| Enzymatic | Alkaline cleaning | Rinse aid | Scent |
| cleaning | preparation | | |
| preparation | | | |
| Pretreatment | Enzymatic | Alkaline cleaning | Rinse aid |
| preparation | cleaning | preparation | |
| | preparation | | |

According to a particularly preferred embodiment of the invention, the dishwashing machine and the dispenser interact in such a way that 1 mg to 1 g of surfactant are released in the rinse program of the dishwashing machine per m² of washing compartment wall area. In this way it is ensured that the walls of the washing compartment retain their degree of gloss even after a large number of washing cycles and the dispensing system retains its optical transmission capacity.

It is additionally advantageous for the dishwashing machine and the dispenser to interact in such a way that in the prewash and/or main wash program of the dishwashing machine at least one enzyme-containing preparation and/or alkaline preparation is released, the enzyme-containing preparation preferably being released before the alkaline preparation.

Energy source: For the purposes of the present application, an energy source is taken to mean a component of the dispensing device which is capable of providing energy which is suitable for operation of the dispensing system or of the dispenser. The energy source is preferably configured such that the dispensing system is autonomous.

The energy source preferably provides electrical energy. The energy source may for example comprise a battery, a storage battery, a mains energy supply, solar cells or the like.

It is particularly advantageous to make the energy source interchangeable, for example in the form of a replaceable battery.

A battery may for example be selected from the group of alkali-manganese batteries, zinc-carbon batteries, nickel-oxyhydroxide batteries, lithium batteries, lithium-iron sulfide batteries, zinc-air batteries, zinc chloride batteries, mercury oxide-zinc batteries and/or silver oxide-zinc batteries.

Examples of suitable storage batteries are lead storage batteries (lead dioxide/lead), nickel-cadmium storage batteries, nickel-metal hydride storage batteries, lithium-ion storage batteries, lithium-polymer storage batteries, alkali-manganese storage batteries, silver-zinc storage batteries, nickel-hydrogen storage batteries, zinc-bromine storage batteries, sodium-nickel chloride storage batteries and/or nickel-iron storage batteries,

The storage battery may in particular be designed in such a way that it may be rechargeable by induction.

It is however also conceivable to provide mechanical energy sources consisting of one or more helical springs, torsion springs or torsion bars, bending springs, air/gas springs and/or elastomer springs.

The energy source is dimensioned in such a manner that the dispenser may run through approximately 300 dispensing cycles before the energy source is exhausted. It is particularly preferable for the energy source to run through between 1 and 300 dispensing cycles, very particularly preferably between 10 and 300, more preferably between 100 and 300, before the energy source is exhausted.

In addition, means may be provided on the dispensing unit for energy conversion, which generate a voltage by means of which the storage battery is charged. These means may for example take the form of a dynamo, which is driven by the water currents during a washing cycle in a dishwashing machine and outputs the voltage generated in this way to the storage battery.

Light guide, dispenser: An optical transmit and/or receive unit is preferably arranged inside the dispenser, in particular in or on the component carrier, in order to protect the electrical and/or optical components of the transmit and/or receive unit from being affected by water splashes and washing water.

To conduct light out of the surrounding environment of the dispenser to the optical transmit and/or receive unit, a light guide is arranged between the optical transmit and/or receive unit and the surrounding environment of the dispenser, which exhibits light transmittance of at least 75%. The light guide preferably consists of a transparent plastics material with a transmittance of at least 75%. The transmittance of the light guide is defined as transmittance between the surface of the light guide at which light is incoupled from the surrounding environment of the dispenser into the light guide and the surface at which light is outcoupled from the light guide to the optical transmit and/or receive unit. Transmittance may be determined to DIN 5036.

The light guide comprises at least one incoupling and/or outcoupling point at which light from an optical transmit and/or receive unit and/or from the surrounding environment of the dispenser is respectively incoupled and outcoupled.

It is particularly preferable for the light guide to be of single-part construction with the component carrier. Advantageously, the component carrier is therefore made from a transparent material.

To accommodate the incoupling and/or outcoupling point of the light guide and produce an optical connection between light guide and surrounding environment, an orifice is provided in the dispenser. The incoupling and/or outcoupling point may be arranged in the outer circumferential surface in the bottom or top of the dispenser. In order to provide a good transmit and/or receive characteristic for optical signals, it may be advantageous for the incoupling and/or outcoupling point of the light guide to be of lenticular and/or prismatic construction.

The light guide may also be of multi-layer and/or multi-part construction of identical or different materials. It is also possible to provide an air gap between a light guide of multi-layer and/or multi-part form. The transmittance of the light guide is understood in the case of multi-layer and/or multi-part structure as being between the surface of the light guide at which light is incoupled from the surrounding environment of the dispenser into the light guide and the surface at which light is outcoupled from the light guide to the optical transmit and/or receive unit.

In addition, it is preferable for at least two incoupling or outcoupling points of the light guide to be provided relative to the surrounding environment. It is particularly advantageous for the incoupling or outcoupling points on the dispenser to be substantially opposite one another.

Preparation: The dispensing system according to the invention comprises at least one first aqueous surfactant-containing preparation, which in particular has a pH value of less than 5.5, preferably less than 4, particularly preferably less than 3.5 (10% solution, 20° C.). By adjusting the acidity of the surfactant phase, it is possible in particular to prevent lime deposits on the walls of the washing compartment, which may reduce the degree of gloss and the reflectivity of the walls. It has also surprisingly emerged that, by means of such a surfactant preparation, the transmittance of the light guide between the optical transmit and/or receive unit of the dispenser and the surrounding environment of the dispenser may be kept constant even over a large number of washing cycles.

As stated above, wireless signal transmission for controlling the dispensing systems positioned in the washing compartment is ensured and improved according to the invention by means of a specific surfactant-containing preparation to be released in the rinse cycle. In addition to its surfactant content, this preparation is additionally distinguished by its pH value of below 5.5 (10% solution, 20° C.).

The preparations according to the invention contain acidifying agents to adjust the pH value. The proportion by weight of acid(s) in the total weight of the preparation according to the invention amounts, relative to the total weight of the preparation, preferably to between 0.05 and 10 wt. %, preferably between 0.1 and 8 wt. % and in particular between 0.2 and 5 wt. %.

The acidifying agent may take the form of both inorganic acids and organic acids, organic acids being particularly preferred for the purposes of the present application for reasons of consumer protection and handling safety. Particularly preferred organic acids are mono-, oligo- and polycarboxylic acids, in particular citric acid, acetic acid, tartaric acid, succinic acid, glutaric acid, malonic acid, adipic acid, maleic acid, fumaric acid, oxalic acid and homo- or copolymeric polycarboxylic acids. Organic sulfonic acids such as amidosulfonic acids may likewise be used.

Particularly preferred preparations according to the invention contain, relative to their total weight, between 0.05 and 10 wt. %, preferably between 0.1 and 8 wt. % and in particular between 0.2 and 5 wt. % of acetic acid and/or citric acid.

It goes without saying that the preparations according to the invention may also contain salts of the above-stated acids as buffer substances. Preference is here given to alkali metal salts and amongst these in turn to sodium or potassium salts.

In addition to the acidifying agent, a second essential component of preparations according to the invention is surfactants. In addition to anionic and amphoteric surfactants, the group of surfactants in particular also comprises nonionic surfactants, which are particularly preferentially used.

Any nonionic surfactants known to a person skilled in the art may in principle be used as the nonionic surfactants. Examples of suitable nonionic surfactants are alkyl glycosides of the general formula RO(G)ₓ, in which R corresponds to a primary straight-chain or methyl-branched aliphatic residue, in particular methyl-branched in position 2, with 8 to 22, preferably 12 to 18 C atoms and G is the symbol which denotes a glycose unit with 5 or 6 C atoms, preferably glucose. The degree of oligomerization x, which indicates the distribution of monoglycosides and oligoglycosides, is any desired number between 1 and 10; x is preferably 1.2 to 1.4.

Nonionic surfactants of the amine oxide type, for example N-coconut alkyl-N,N-dimethylamine oxide and N-tallow alkyl-N,N-dihydroxyethylamine oxide, and of the fatty acid alkanolamide type may also be suitable. The quantity of these nonionic surfactants preferably amounts to no more than that of the ethoxylated fatty alcohols, in particular no more than half the quantity thereof.

A further class of preferably used nonionic surfactants, which may be used either as sole nonionic surfactant or in combination with other nonionic surfactants, are alkoxylated, preferably ethoxylated or ethoxylated and propoxylated fatty acid alkyl esters, preferably with 1 to 4 carbon atoms in the alkyl chain.

Low-foaming nonionic surfactants are used as preferred surfactants. Washing or cleaning agents, in particular cleaning agents for machine dishwashing, particularly preferentially contain nonionic surfactants from the group of alkoxylated alcohols. Alkoxylated, advantageously ethoxylated, in particular primary alcohols with preferably 8 to 18 C atoms and on average 1 to 12 mol of ethylene oxide (EO) per mol of alcohol, in which the alcohol residue may be linear or preferably methyl-branched in position 2 or may contain linear and methyl-branched residues in the mixture, as are usually present in oxo alcohol residues, are preferably used as nonionic surfactants. In particular, however, alcohol ethoxylates with linear residues prepared from alcohols of natural origin with 12 to 18 C atoms, for example from coconut, palm, tallow fat or oleyl alcohol, and on average 2 to 8 mol of EO per mol of alcohol are preferred. Preferred ethoxylated alcohols include, for example, C₁₂₋₁₄ alcohols with 3 EO or 4 EO, C₉₋₁₁ alcohol with 7 EO, C₁₃₋₁₅ alcohols with 3 EO, 5 EO, 7 EO or 8 EO, C₁₂₋₁₈ alcohols with 3 EO, 5 EO or 7 EO and mixtures of these, such as mixtures of C₁₂₋₁₄ alcohol with 3 EO and C₁₂₋₁₈ alcohol with 5 EO. The stated degrees of ethoxylation are statistical averages which, for a specific product, may be an integer or a fractional number. Preferred alcohol ethoxylates have a narrow homolog distribution (narrow range ethoxylates, NRE). In addition to these nonionic surfactants, fatty alcohols with more than 12 EO may also be used. Examples of these are tallow fatty alcohol with 14 EO, 25 EO, 30 EO or 40 EO.

Ethoxylated nonionic surfactants which were obtained from C₆₋₂₀ monohydroxy-alkanols or C₆₋₂₀ alkylphenols or C₁₆₋₂₀ fatty alcohols and more than 12 mol, preferably more than 15 mol and in particular more than 20 mol of ethylene oxide per mol of alcohol are accordingly particularly preferentially used. One particularly preferred nonionic surfactant is obtained from a straight-chain fatty alcohol having 16 to 20 carbon atoms (C₁₆₋₂₀ alcohol), preferably a C₁₈ alcohol, and at least 12 mol, preferably at least 15 mol and in particular at least 20 mol of ethylene oxide. Among these, “narrow range ethoxylates” are particularly preferred.

In particular, nonionic surfactants having a melting point of above room temperature are preferred. Nonionic surfactant(s) with a melting point of above 20° C., preferably of above 25° C., particularly preferably of between 25 and 60° C. and in particular of between 26.6 and 43.3° C., is/are particularly preferred.

Nonionic surfactants from the group of alkoxylated alcohols, particularly preferably from the group of mixed alkoxylated alcohols and in particular from the group of EO-AO-EO nonionic surfactants, are likewise particularly preferentially used.

The nonionic surfactant which is solid at room temperature preferably comprises propylene oxide units in its molecule. Such PO units preferably constitute up to 25 wt. %, particularly preferably up to 20 wt. % and in particular up to 15 wt. % of the total molar mass of the nonionic surfactant. Particularly preferred nonionic surfactants are ethoxylated monohydroxyalkanols or alkylphenols which additionally comprise polyoxyethylene/polyoxypropylene block copolymer units. The alcohol or alkylphenol moiety of such nonionic surfactant molecules here preferably constitutes more than 30 wt. %, particularly preferably more than 50 wt. % and in particular more than 70 wt. % of the total molar mass of such nonionic surfactants. Preferred agents are characterized in that they contain ethoxylated and propoxylated nonionic surfactants, in which the propylene oxide units constitute in each molecule up to 25 wt. %, preferably up to 20 wt. % and in particular up to 15 wt. % of the entire molar mass of the nonionic surfactant.

Preferably used surfactants originate from the groups comprising alkoxylated nonionic surfactants, in particular ethoxylated primary alcohols and mixtures of these surfactants with structurally complex surfactants such as polyoxypropylene/polyoxyethylene/polyoxypropylene ((PO/EO/PO) surfactants). Such (PO/EO/PO) nonionic surfactants are furthermore distinguished by good foam control.

Further nonionic surfactants with a melting point above room temperature which are particularly preferably to be used contain 40 to 70% of a polyoxypropylene/polyoxyethylene/polyoxypropylene block polymer blend, which contains 75 wt. % of a reverse block copolymer of polyoxyethylene and polyoxypropylene with 17 mol of ethylene oxide and 44 mol of propylene oxide and 25 wt. % of a block copolymer of polyoxyethylene and polyoxypropylene, initiated with trimethylolpropane and containing 24 mol of ethylene oxide and 99 mol of propylene oxide per mol of trimethylolpropane.

Nonionic surfactants which have proved to be particularly preferred for the purposes of the present invention are low-foaming nonionic surfactants which comprise alternating ethylene oxide and alkylene oxide units. Among these, surfactants with EO-AO-EO-AO blocks are in turn preferred, with in each case one to ten EO or AO groups being attached to one another before being followed by a block of the respective other groups. Preferred nonionic surfactants are those of the general formula

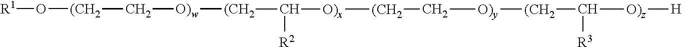

in which R¹ denotes a straight-chain or branched, saturated or mono- or polyunsaturated C₆₋₂₄ alkyl or alkenyl residue; each group R² or R³ is mutually independently selected from —CH₃, —CH₂CH₃, —CH₂CH₂—CH₃, CH(CH₃)₂ and the indices w, x, y, z mutually independently denote integers from 1 to 6.

The preferred nonionic surfactants of the above formula may be produced by known methods from the corresponding alcohols R¹—OH and ethylene or alkylene oxide. Residue R¹ in the above formula may vary depending on the origin of the alcohol. If natural sources are used, the residue R¹ comprises an even number of carbon atoms and is generally unbranched, preference being given to linear residues from alcohols of natural origin with 12 to 18 C atoms, for example from coconut, palm, tallow fat or oleyl alcohol. Alcohols obtainable from synthetic sources are for example Guerbet alcohols or residues methyl-branched in position 2 or linear and methyl-branched residues in a mixture as are conventionally present in oxo alcohol residues. Irrespective of the nature of the alcohol used for producing nonionic surfactants contained in the preparations, preferred nonionic surfactants are those in which R¹ in the above formula denotes an alkyl residue with 6 to 24, preferably 8 to 20, particularly preferably 9 to 15 and in particular 9 to 11 carbon atoms.

Apart from propylene oxide, butylene oxide may in particular be considered as the alkylene oxide unit which alternates with the ethylene oxide unit in preferred nonionic surfactants. However, further alkylene oxides, in which R² or R³ are mutually independently selected from —CH₂CH₂—CH₃ or —CH(CH₃)₂ are also suitable. Nonionic surfactants of the above formula which are preferably used are those in which R² or R³ denotes a residue —CH₃, w and x mutually independently denote values of 3 or 4 and y and z mutually independently denote values of 1 or 2.

In summary, preferred nonionic surfactants are in particular those which comprise a C₉₋₁₅ alkyl residue with 1 to 4 ethylene oxide units, followed by 1 to 4 propylene oxide units, followed by 1 to 4 ethylene oxide units, followed by 1 to 4 propylene oxide units. In aqueous solution, these surfactants exhibit the necessary low viscosity and may particularly preferentially be used according to the invention.

Surfactants of the general formula R¹—CH(OH)CH₂O-(AO)_{w}-(A′O)ₓ-(A″O)_{y}-(A′″O)_{z}—R², in which R¹ and R² mutually independently denote a straight-chain or branched, saturated or mono- or polyunsaturated C₂₋₄₀ alkyl or alkenyl residue; A, A′, A″ and A′″ mutually independently denote a residue from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃); and w, x, y and z denote values between 0.5 and 90, with x, y and/or z possibly also being 0, are preferred according to the invention.

In particular, preferred end group-terminated poly(oxyalkylated) nonionic surfactants are those which, according to the formula R¹O[CH₂CH₂O]ₓCH₂CH(OH)R², in addition to a residue R¹, which denotes linear or branched, saturated or unsaturated, aliphatic or aromatic hydrocarbon residues with 2 to 30 carbon atoms, preferably with 4 to 22 carbon atoms, furthermore comprise a linear or branched, saturated or unsaturated, aliphatic or aromatic hydrocarbon residue R² with 1 to 30 carbon atoms, x denoting values between 1 and 90, preferably values between 30 and 80 and in particular values between 30 and 60.

Particularly preferred surfactants are those of the formula R¹O[CH₂CH(CH₃)O]ₓ[CH₂CH₂O]_{y}CH₂CH(OH)R², in which R¹ denotes a linear or branched aliphatic hydrocarbon residue with 4 to 18 carbon atoms or mixtures thereof, R² denotes a linear or branched hydrocarbon residue with 2 to 26 carbon atoms or mixtures thereof and x denotes values between 0.5 and 1.5 and y denotes a value of at least 15.

Particularly preferred end group-terminated poly(oxyalkylated) nonionic surfactants are furthermore those of the formula R¹O[CH₂CH₂O]ₓ[CH₂CH(R³)O]_{y}CH₂CH(OH)R², in which R¹ and R² mutually independently denote a linear or branched, saturated or mono- or polyunsaturated hydrocarbon residue with 2 to 26 carbon atoms, R³ is mutually independently selected from —CH₃, —CH₂CH₃, —CH₂CH₂—CH₃, —CH(CH₃)₂, but preferably denotes —CH₃, and x and y mutually independently denote values between 1 and 32, with nonionic surfactants with R³═—CH₃ and values of x from 15 to 32 and y of 0.5 and 1.5 being very particularly preferred.

Thanks to the use of the above-described nonionic surfactants with a free hydroxyl group on one of the two terminal alkyl residues, it is possible to achieve a distinct improvement in the formation of film deposits in machine dishwashing in comparison with conventional polyalkoxylated fatty alcohols without a free hydroxyl group.

Further preferably usable nonionic surfactants are the end group-terminated poly(oxyalkylated) nonionic surfactants of the formula R¹O[CH₂CH(R³)O]ₓ[CH₂]ₖCH(OH)[CH₂]ⱼOR², in which R¹ and R² denote linear or branched, saturated or unsaturated, aliphatic or aromatic hydrocarbon residues with 1 to 30 carbon atoms, R³ denotes H or a methyl, ethyl, n-propyl, iso-propyl, n-butyl, 2-butyl or 2-methyl-2-butyl residue, x denotes values between 1 and 30, k and j denote values between 1 and 12, preferably between 1 and 5. If the value of x is >2, each R³ in the above formula R¹O[CH₂CH(R³)O]ₓ[CH₂]ₖCH(OH)[CH₂]ⱼOR² may be different. R′ and R² are preferably linear or branched, saturated or unsaturated, aliphatic or aromatic hydrocarbon residues with 6 to 22 carbon atoms, residues with 8 to 18 C atoms being particularly preferred. H, —CH³ or —CH₂CH₃ are particularly preferred for the residue R₃. Particularly preferred values for x are in the range from 1 to 20, in particular from 6 to 15.

As described above, each R³ in the above formula may be different if x is >2. In this manner, it is possible to vary the alkylene oxide unit in the square brackets. For example, if x denotes 3, the residue R³ may be selected in order to form ethylene oxide (R³═H) or propylene oxide (R³═CH₃) units, which may be attached to one another in any sequence, for example (EO)(PO)(EO), (EO)(EO)(PO), (EO)(EO)(EO), (PO)(EO)(PO), (PO)(PO)(EO) and (PO)(PO)(PO). The value 3 for x has been selected here by way of example and may perfectly well be larger, the range of variation increasing as the value of x rises and for example comprising a large number of (EO) groups combined with a small number of (PO) groups, or vice versa.

Particularly preferred end group-terminated poly(oxyalkylated) alcohols of the above-stated formula have values of k=1 and j=1, so simplifying the above formula to R¹O[CH₂CH(R³)O]ₓCH₂CH(OH)CH₂OR². In the latter-stated formula, R¹, R² and R³ are as defined above and x denotes numbers from 1 to 30, preferably from 1 to 20 and in particular from 6 to 18. Particularly preferred surfactants are those in which the residues R¹ and R² comprise 9 to 14 C atoms, R³ denotes H and x assumes values from 6 to 15.

The stated C chain lengths and degrees of ethoxylation or degrees of alkoxylation of the above-stated nonionic surfactants are statistical averages which, for a specific product, may be an integer or a fractional number. Due to production methods, commercial products of the stated formulae do not in the main consist of an individual representative, but instead of mixtures, whereby not only the C-chain lengths but also the degrees of ethoxylation or degrees of alkoxylation may be averages and consequently fractional numbers.

The above-stated nonionic surfactants may, of course, be used not only as individual substances, but also as surfactant mixtures of two, three, four or more surfactants. Surfactant mixtures do not here comprise mixtures of nonionic surfactants all of which fall within one of the above-stated general formulae, but instead such mixtures which contain two, three, four or more nonionic surfactants which may be described by various of the above-stated general formulae.

The proportion by weight of nonionic surfactants in the total weight of the preparation according to the invention amounts in a preferred embodiment to between 1.0 and 25 wt. %, preferably between 2.0 and 20 wt. %, preferably between 3.0 and 17 wt. % and in particular between 5.0 and 15 wt. %.

The preparations according to the invention for release in the rinse cycle contain water, the proportion by weight of the water in the total weight of the composition preferably amounting to between 1.0 and 90 wt. %, preferably between 2.0 and 80 wt. % and in particular between 5.0 and 70 wt. %. Very particularly preferred preparations have a water content of between 30 and 90 wt. %, preferably between 40 and 80 wt. % and in particular between 50 and 70 wt. %.

In addition to the above-stated ingredients, the preparations according to the invention may contain nonaqueous solvents. It has been demonstrated that, by adding organic solvents, the surface properties of the walls of the washing compartment may be influenced in a manner favorable to the desired signal transmission. The proportion by weight of the organic solvents in the total weight of the preparation according to the invention preferably amounts to between 1.0 and 30 wt. %, preferably between 2.0 and 25 wt. % and in particular between 4.0 and 20 wt. %.

Nonaqueous solvents which may be used in the preparations according to the invention originate for example from the group of mono- or polyhydric alcohols, alkanolamines or glycol ethers. The solvents are preferably selected from ethanol, n- or i-propanol, butanols, glycol, propanediol or butanediol, glycerol, diglycol, diethylene glycol monopropyl or monobutyl ether, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol methyl or ethyl ether, methoxy-, ethoxy- or butoxytriglycol, 1-butoxyethoxy-2-propanol, 3-methyl-3-methoxybutanol, propylene glycol t-butyl ether, 1,2-propylene glycol and mixtures of these solvents.

The organic solvents from the group of organic amines and/or alkanolamines have proven particularly effective with regard to advantageously influencing signal transmission in the washing compartment.

Primary and secondary alkylamines, alkyleneamines and mixtures of these organic amines are particularly preferred as organic amines. The group of preferred primary alkylamines include monomethylamine, monoethylamine, monopropylamine, monobutylamine, monopentylamine and cyclohexylamine. The group of preferred secondary alkylamines includes in particular dimethylamine.

Preferred alkanolamines are in particular primary, secondary and tertiary alkanolamines and mixtures thereof. Particularly preferred primary alkanolamines are monoethanolamine (2-aminoethanol, MEA), monoisopropanolamine, diethylethanolamine (2-(diethylamino)-ethanol). Particularly preferred secondary alkanolamines are diethanolamine (2,2′-iminodiethanol, DEA, bis(2-hydroxyethyl)amine), N-methyldiethanolamine, N-ethyldiethanolamine, diisopropanolamine and morpholine. Particularly preferred tertiary alkanolamines are triethanolamine and triisopropanolamine.

The preparations according to the invention may additionally contain hydrotropes. Preferred hydrotropes are xylene- and cumenesulfonate as well as urea and N-methylacetamide.

Preparations preferred for the purposes of the present invention contain toluene-, cumene- or xylenesulfonate in quantities of 0.5 to 15 wt. %, preferably of 1.0 to 12 wt. %, particularly preferably of 2.0 to 10 wt. % and in particular of 2.5 to 8 wt. %, in each case relative to the total weight of the preparation.

To prevent the formation of cloudiness, streaks and scratches on dishwasher-cleaned glass surfaces, the preparations according to the invention may contain glass corrosion inhibitors. Preferred glass corrosion inhibitors originate from the group of zinc salts and zinc complexes.

The spectrum of zinc salts preferred according to the invention, preferably the zinc salts of organic acids, particularly preferably the zinc salts of organic08:14 carboxylic acids, extends from salts which are sparingly soluble or insoluble in water, i.e. exhibit a solubility of below 100 mg/l, preferably of below 10 mg/l, in particular of below 0.01 mg/l, up to those salts which exhibit a solubility in water of above 100 mg/l, preferably of above 500 mg/l, particularly preferably of above 1 g/l and in particular of above 5 g/l (all solubilities at 20° C. water temperature). The first group of zinc salts includes for example zinc citrate, zinc oleate and zinc stearate, while the group of soluble zinc salts includes for example zinc formate, zinc acetate, zinc lactate and zinc gluconate.

At least one zinc salt of an organic carboxylic acid, particularly preferably a zinc salt from the group of zinc stearate, zinc oleate, zinc gluconate, zinc acetate, zinc lactate and zinc citrate is particularly preferentially used as a glass corrosion inhibitor. Zinc ricinoleate, zinc abietate and zinc oxalate are also preferred.

A number of exemplary formulations for preferred preparations according to the invention may be found in the following tables:

| | No. 1 | No. 2 | No. 3 | No. 4 | No. 5 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Misc. | Ad 100 | Ad 100 | Ad 100 | Ad 100 | Ad 100 |

| | No. 6 | No. 7 | No. 8 | No. 9 | No. 10 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acetic acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Misc. | Ad 100 | Ad 100 | Ad 100 | Ad 100 | Ad 100 |

| | No. 11 | No. 12 | No. 13 | No. 14 | No. 15 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Citric acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Misc. | Ad 100 | Ad 100 | Ad 100 | Ad 100 | Ad 100 |

| | No. 16 | No. 17 | No. 18 | No. 19 | No. 20 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Org. solvent | 0-30 | 0 to 25 | 0 to 25 | 0-20 | 0-20 |
| Hydrotrope | 0-15 | 0-12 | 0-10 | 0-8 | 0-8 |
| Misc. | Ad 100 | Ad 100 | Ad 100 | Ad 100 | Ad 100 |

| | No. 21 | No. 22 | No. 23 | No. 24 | No. 25 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acetic acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Org. solvent | 0-30 | 0 to 25 | 0 to 25 | 0-20 | 0-20 |
| Hydrotrope | 0-15 | 0-12 | 0-10 | 0-8 | 0-8 |
| Misc. | Ad 100 | Ad 100 | Ad 100 | Ad 100 | Ad 100 |

| | No. 26 | No. 27 | No. 28 | No. 29 | No. 30 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Citric acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Org. solvent | 0-30 | 0 to 25 | 0 to 25 | 0-20 | 0-20 |
| Hydrotrope | 0-15 | 0-12 | 0-10 | 0-8 | 0-8 |
| Misc. | Ad 100 | Ad 100 | Ad 100 | Ad 100 | Ad 100 |

| | No. 31 | No. 32 | No. 33 | No. 34 | No. 35 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| 1,2-Propylene glycol | 1.0-30 | 2.0 to | 2.0 to | 4.0-20 | 4.0-20 |
| | | 25 | 25 | | |
| Misc. | Ad 100 | Ad 100 | Ad 100 | Ad 100 | Ad 100 |

| | No. 36 | No. 37 | No. 38 | No. 39 | No. 40 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acetic acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| 1,2-Propylene glycol | 1.0-30 | 2.0 to | 2.0 to | 4.0-20 | 4.0-20 |
| | | 25 | 25 | | |
| Misc. | Ad 100 | Ad 100 | Ad 100 | Ad 100 | Ad 100 |

| | No. 41 | No. 42 | No. 43 | No. 44 | No. 45 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Na cumenesulfonate | 0.5-15 | 1.0-12 | 2.0-10 | 2.5-8 | 2.5-8 |
| Misc. | Ad 100 | Ad 100 | Ad 100 | Ad 100 | Ad 100 |

| | No. 46 | No. 47 | No. 48 | No. 49 | No. 50 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acetic acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Na cumenesulfonate | 0.5-15 | 1.0-12 | 2.0-10 | 2.5-8 | 2.5-8 |
| Misc. | Ad 100 | Ad 100 | Ad 100 | Ad 100 | Ad 100 |

| | No. 51 | No. 52 | No. 53 | No. 54 | No. 55 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Org. solvent | 1.0-30 | 2.0 to | 2.0 to | 4.0-20 | 4.0-20 |
| | | 25 | 25 | | |
| Hydrotrope | 0.5-15 | 1.0-12 | 2.0-10 | 2.5-8 | 2.5-8 |
| Misc. | Ad 100 | Ad 100 | Ad 100 | Ad 100 | Ad 100 |

| | No. 56 | No. 57 | No. 58 | No. 59 | No. 60 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acetic acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| 1,2-Propylene glycol | 1.0-30 | 2.0 to | 2.0 to | 4.0-20 | 4.0-20 |
| | | 25 | 25 | | |
| Na cumenesulfonate | 0.5-15 | 1.0-12 | 2.0-10 | 2.5-8 | 2.5-8 |
| Misc. | Ad 100 | Ad 100 | Ad 100 | Ad 100 | Ad 100 |

| | No. 61 | No. 62 | No. 63 | No. 64 | No. 65 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acetic acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| 1,2-Propylene glycol | 1.0-30 | 2.0 to | 2.0 to | 4.0-20 | 4.0-20 |
| | | 25 | 25 | | |
| Na cumenesulfonate | 0.5-15 | 1.0-12 | 2.0-10 | 2.5-8 | 2.5-8 |
| Zinc salt | 0.1 to | 0.2 to | 0.2 to | 0.5 to | 0.5 to |
| | 4.0 | 3.0 | 3.0 | 2.0 | 2.0 |
| Misc. | Ad 100 | Ad 100 | Ad 100 | Ad 100 | Ad 100 |

It is moreover advantageous for obtaining and/or improving the degree of gloss of the washing compartment walls for at least one surfactant, at least one polymer and at least one phosphonate to be released from one or more preparations into the washing liquor, these components being selected such that at least the surfactant and the polymer adhere to the surface of the light guide directed into the washing compartment. This improves run-off of washing liquid from and drying of the walls, so reducing deposits on the walls, for example in the form of water spots. In addition, the surfactants and/or polymers adhering to the walls provide a kind of sealing finish on the wall surfaces, such that fresh adhesion of foreign matter may be prevented.

The invention is illustrated in greater detail below with reference to drawings which represent merely exemplary embodiments. Particularly preferred developments and particularly preferred combinations of features are also further described in detail in the figures.

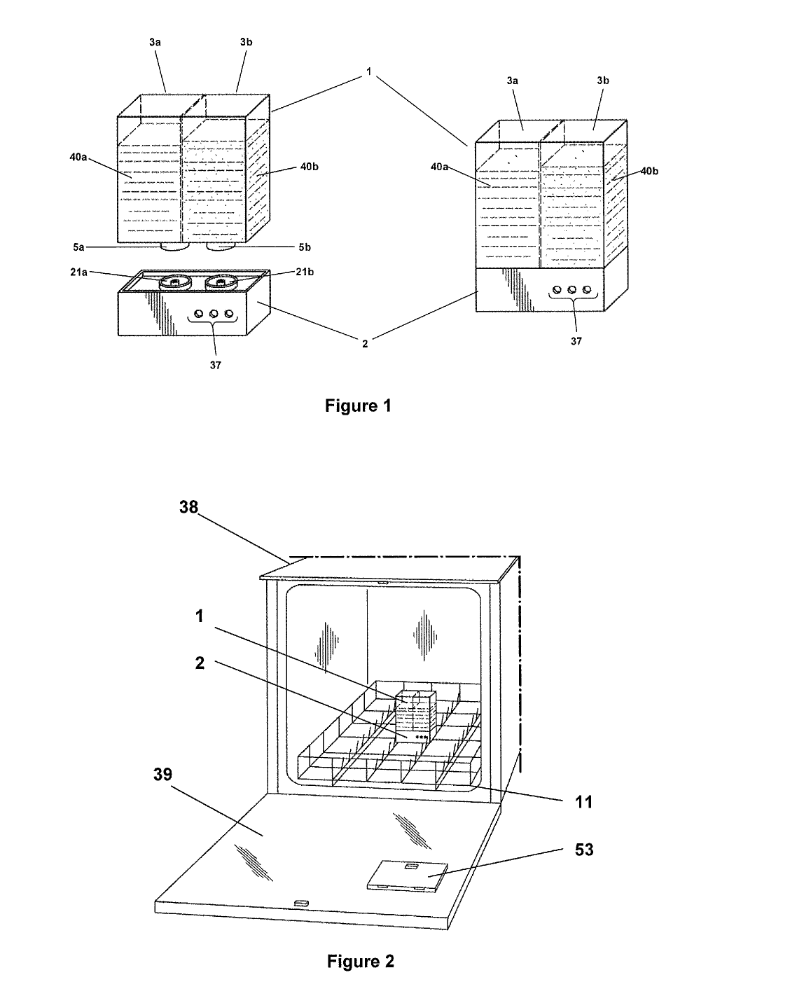

FIG. 1 shows an autonomous dispenser 2 with a two-chamber cartridge 1 in the separated and assembled states.

The dispenser 2 comprises two dispensing chamber inlets 21a, 21b for repeatedly detachable accommodation of the corresponding outlet orifices 5a, 5b of the chambers 3a, 3b of the cartridge 1. Indicator and operating elements 37, which indicate the operating state of the dispenser 2 or have an effect thereon, are located on the front.

The dispensing chamber inlets 21a, 21b additionally comprise means which, when the cartridge 1 is placed on the dispenser 2, bring about opening of the outlet orifices 5a, 5b of the chambers 3a, 3b, such that the interior of the chambers 3a, 3b is connected in communicating manner to the dispensing chamber inlets 21a, 21b.

The cartridge 1 may consist of one or more chambers 3a, 3b. The cartridge 1 may be of single-part construction comprising a plurality of chambers 3a, 3b or be of multi-part construction, wherein the individual chambers 3a, 3b are then assembled to form a cartridge 1, in particular by bonded, interlocking or frictional connection methods.

In particular, fixing may be effected by one or more of the connection types from the group of snap-in connections, press connections, melt connections, adhesive connections, welded connections, brazed connections, screw connections, keyed connections, clamped connections or rebound connections. In particular, fixing may also be provided by a heat-shrinkable sleeve, which is drawn in the heated state over at least portions of the cartridge and firmly envelops the cartridge in the cooled state.

The bottom of the cartridge 1 may be inclined in the manner of a funnel towards the release orifice 5a, 5b in order to provide the cartridge 1 with advantageous residual emptying characteristics. Moreover, the internal wall of the cartridge 1 may be constructed by suitable material selection and/or surface finish such that the product adheres only slightly to the internal wall of the cartridge. The residual emptying characteristics of the cartridge 1 may also be further optimized by this measure.

The chambers 3a, 3b of the cartridge 1 may be of identical or different capacities. In a configuration with two chambers 3a, 3b, the ratio of the chamber volumes is preferably 5:1; in a configuration with three chambers preferably 4:1:1, these configurations in particular being suitable for use in dishwashing machines.

One possible connection method may also consist in plugging the chambers 3a, 3b into one of the corresponding dispensing chamber inlets 21a, 21b of the dispenser 2 and thereby fixing them relative to one another.

The connection between the chambers 3a, 3b may in particular be detachable, so as to allow separate replacement of chambers.

The chambers 3a, 3b each contain a preparation 40a, 40b. The preparation 40a, 40b may be of the same or different composition.

Advantageously, the chambers 3a, 3b are made of a transparent material, such that the filling level of the preparations 40a, 40b is visible to the user from outside. It may however also be advantageous to make at least one of the chambers from an opaque material, in particular when the preparation located in this chamber contains light-sensitive ingredients.

The outlet orifices 5a, 5b are designed such that they form an interlocking and/or frictional, in particular liquid-tight, connection with the corresponding dispensing chamber inlets 21a, 21b.

It is particularly advantageous for each of the outlet orifices 5a, 5b to be configured such that it fits onto only one of the dispensing chamber inlets 21a, 21b, so preventing a chamber from being inadvertently plugged onto an incorrect dispensing chamber inlet.

The cartridge conventionally has a capacity of <5000 ml, in particular <1000 ml, preferably <500 ml, particularly preferably <250 ml, very particularly preferably <50 ml.

In the assembled state, the dispensing unit 2 and the cartridge 1 may be adapted in particular to the geometries of the devices on or in which they are used, so as to ensure the smallest possible loss in useful volume. To use the dispensing unit 2 and the cartridge 1 in dishwashing machines it is particularly advantageous to shape the dispensing unit 2 and the cartridge 1 in imitation of dishes to be cleaned in dishwashing machines. The dispensing unit 2 and the cartridge 1 may, for example, be plate-shaped, approximately assuming the dimensions of a plate. In this way, the dispensing unit may be positioned in space-saving manner in the lower basket.

In order to provide direct visual checking of filling level, it is advantageous to form the cartridge 1 at least in portions of a transparent material.

In order to protect heat-sensitive components of a product present in a cartridge from exposure to heat, it is advantageous to produce the cartridge 1 from a material with low thermal conductivity.

The outlet orifices 5a, 5b of the cartridge 1 are preferably arranged in a line or row, so making a slender, plate-shaped configuration of the dispenser possible.

FIG. 2 shows an autonomous dispenser with a two-chamber cartridge 1 in the crockery drawer 11 when the door 39 of a dishwashing machine 38 is open. It will be noted that the dispenser 2 may be positioned together with the cartridge 1 in principle at any desired point within the crockery drawer 11, wherein it is advantageous for a plate- or cup-shaped dispensing system 1, 2 to be provided in a corresponding plate or cup receptacle in the crockery drawer 11. In the dishwashing machine door 39 there is located a dispensing chamber 53, into which a dishwashing machine cleaning preparation may be introduced, for example in the form of a tablet. If the dispensing system 1, 2 is in the operational state inside the dishwasher 38, the addition of cleaning preparation for each washing cycle via the dispensing chamber 53 is not necessary, since cleaning agent release is provided for a plurality of washing cycles via the dispensing system 1, 2, this being explained below in greater detail. An advantage of this embodiment of the invention is that, when the autonomous dispensing system 1, 2 is arranged in the lower crockery drawer 11, preparations 40a, 40b are released from the cartridge 1 directly via the outlet orifices arranged at the bottom of the dispenser into the washing liquor, such that quick dissolution and uniform distribution of the washing preparations in the washing program is ensured.

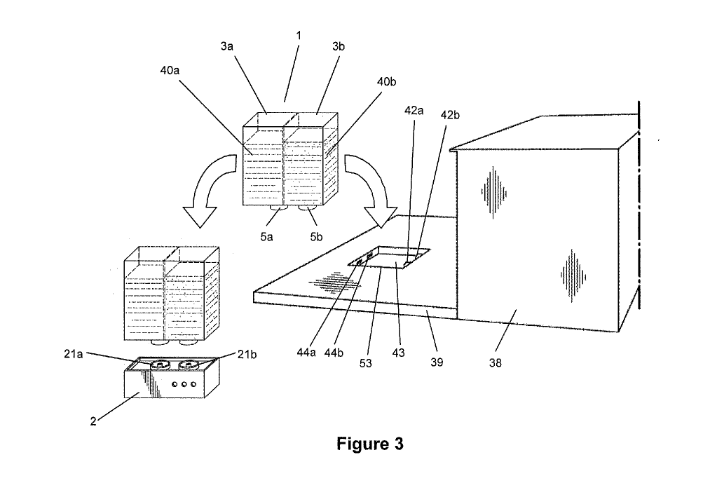

FIG. 3 shows a two-chamber cartridge 1 in the separated state for an autonomous dispenser 2 and an internal dispenser integral to the machine Here the cartridge 1 is designed in such a way that it is couplable both to the autonomous dispenser 2 and to the dispenser integral to the machine (not shown), which is indicated by the arrows shown in FIG. 3.

On the side of the dishwashing machine door 39 directed towards the interior of the dishwashing machine 38, a recess 43 is formed, into which the cartridge 1 may be inserted, wherein by such insertion the outlet orifices 5a, 5b of the cartridge 1 are connected in communicating manner with the adapter pieces 42a, 42b. The adapter pieces 42a, 42b are in turn coupled to the dispenser integral to the machine.

To fix the cartridge 1 in the recess 43, retaining elements 44a, 44b may be provided on the recess 43, which ensure frictional and/or interlocking fixing of the cartridge in the recess 43. It goes without saying that it is also conceivable for corresponding retaining elements to be provided on the cartridge 1. The retaining elements 44a, 44b may preferably be selected from the group of snap-fit connections, latching connections, snap-fit/latching connections, clamped connections or plug-in connections.

When the dishwashing machine 38 is in operation, preparation 40a, 40b from the cartridge 1 is introduced by the dispenser integral to the machine through the adapter elements 42a, 42b to the corresponding washing cycle.

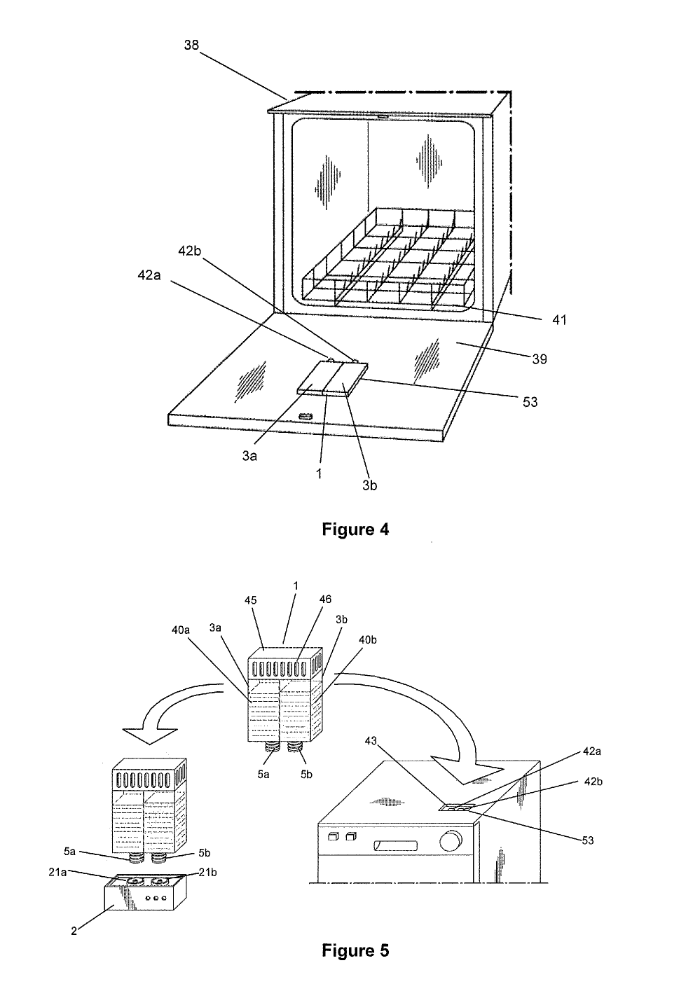

FIG. 4 shows the cartridge 1 known from FIG. 3 installed in the door 39 of a dishwashing machine 38.

Another embodiment of the invention is shown in FIG. 5. FIG. 5 shows the cartridge 1 known from FIG. 3 with a chamber 45 arranged on the top of the cartridge 1, which chamber comprises a plurality of orifices 46 in its outer circumferential surface. Preferably, the chamber 45 is filled with an air freshening preparation, which is released through the orifices 46 into the surrounding environment. The air freshening preparation may comprise in particular at least one scent and/or one odor-controlling substance.

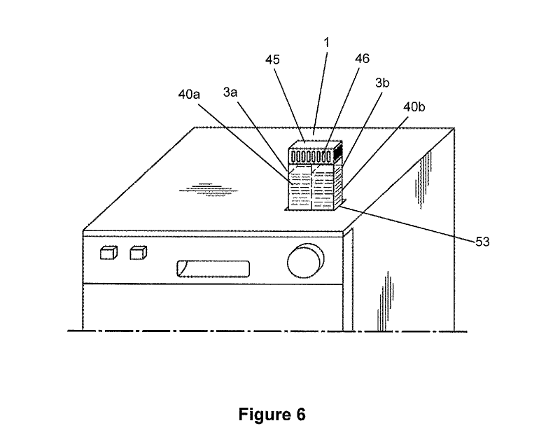

Unlike with the arrangement known from FIG. 3 and FIG. 4 of the cartridge 1 in the interior of a dishwashing machine 38, it is also possible to provide a recess 43 with adapter elements 42a, 42b for coupling to the cartridge 1 on an external surface of a dishwashing machine 38. This is shown by way of example in FIG. 5 and FIG. 6.

It goes without saying that the cartridge 1 illustrated in FIG. 5 and FIG. 6 may also be arranged with a chamber 45 containing an air freshening substance in a correspondingly constructed receptacle in the interior of a dishwashing machine 38.

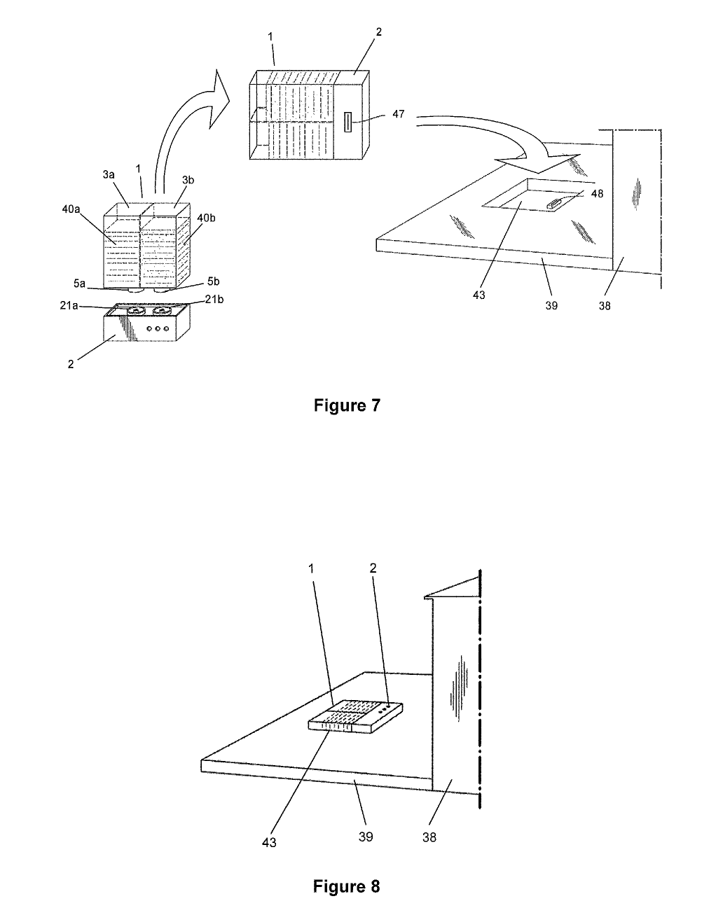

A further development of the invention is shown in FIG. 7. The dispenser 2 may here be coupled to the cartridge 1, this being indicated accordingly in the drawing by the first, left-hand arrow. Then, cartridge 1 and dispenser 2 are coupled as an assembly via the interface 47, 48 to the dishwasher, as shown by the right-hand arrow. The dispenser 2 comprises an interface 47, via which data and/or energy are transmitted to and/or from the dispenser 2. In the door 39 of the dishwasher 38 a recess 43 is provided for accommodating the dispenser 2. In the recess 43 a second interface 48 is provided, which transmits data and/or energy to and/or from the dispenser 2.

Preferably, data and/or energy are exchanged wirelessly between the first interface 47 on the dispenser 2 and the second interface 48 on the dishwasher 38. It is particularly preferable for energy to be transmitted from the interface 48 of the dishwasher 38 wirelessly via the interface 47 to the dispenser 2. This may, for example, proceed inductively and/or capacitively.

It is furthermore advantageous for the interface for data transmission also to be of wireless configuration. This may be achieved using the methods known in the prior art for wireless data transmission, such as for example by means of radio transmission or IR transmission.

Alternatively, the interfaces 47, 48 may also take the form of integral plug-in connections. Advantageously, the plug-in connections are configured in such a way that they are protected from the ingress of water or moisture.

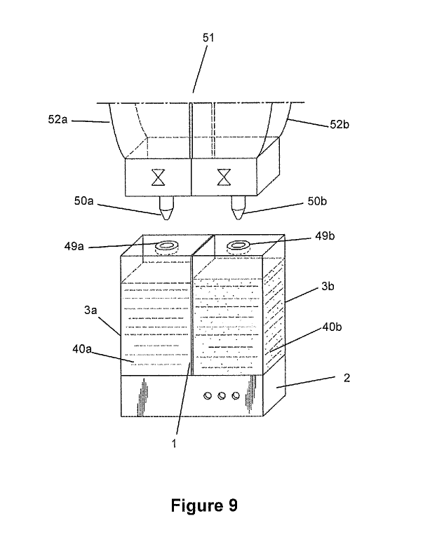

FIG. 9 shows a cartridge 1, the chambers 3a, 3b of which may be filled by way of the orifices 49a, 49b in the top for example by means of a refill cartridge 51. The orifices 49a, 49b in the cartridge 1 may for example take the form of silicone valves, which open when pierced by the adapter 50a, 50b and close again upon removal of the adapter 50a, 50b, such that preparation is prevented from flowing unintentionally out of the cartridge.

The adapters 50a, 50b are designed such that they may pierce the orifices 49a, 49b in the cartridge 1. Advantageously, the orifices 49a, 49b in the cartridge 1 and the adapter 50a, 50b are configured with regard to position and size in such a way that the adapter can only engage in the orifices 49a, 49b in a predefined position. In this way, incorrect filling of the cartridge chambers 3a, 3b may in particular be prevented, and it is ensured that in each case the same or a compatible preparation passes from a chamber 52a, 52b of the refill cartridge 51 into the corresponding chamber 3a, 3b of the cartridge 1.

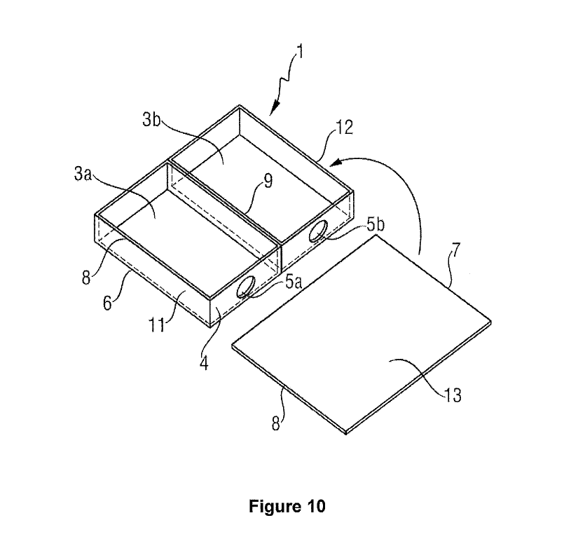

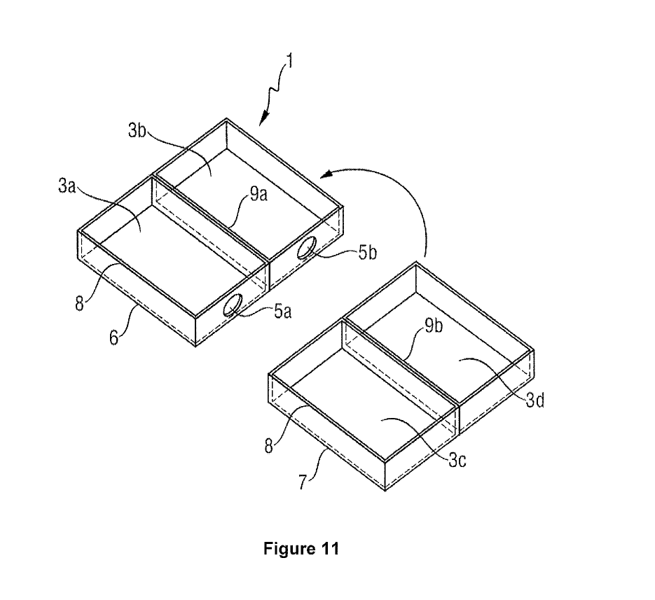

Further exemplary embodiments of the cartridge known from the above figures are shown in FIG. 10 to FIG. 16.

In a first embodiment, which is reproduced in FIG. 10, the cartridge 1 consists of a first trough-shaped element 6 and a second plate- or lid-like element 7, the two elements 6, 7 being shown unassembled in FIG. 10. The second, plate- or lid-like element 7 is dimensioned such that, when the cartridge 1 is in the assembled state, it completely covers the first trough-shaped element 6 along the connecting edge 8.

The first, trough-shaped element 6 is formed by the cartridge top 10, the cartridge side faces 11 and 12 and the cartridge bottom 4. The two chambers 3a, 3b of the cartridge 1 are defined by the separating web 9. An outlet orifice 5a, 5b is in each case provided in the cartridge bottom 4 for each of the chambers 3a, 3b. The cartridge 1 is formed by bonding together the first, trough-shaped element 6 and the second, plate- or lid-like element 7.

A further possible embodiment of the cartridge is shown in FIG. 11, in which two cartridge elements 6, 7 are likewise shown in the as yet unassembled state. The two cartridge elements 6, 7 are in this case of mirror-symmetrical construction, such that in the assembled state the connecting edges 8 of the two elements 6, 7 rest fully on one another. The outlet orifices 5a and 5b are here formed merely in the bottom 4 of the first cartridge element 6, such that the connecting edge 8 of the elements 6, 7 extends on the cartridge bottom 4 at a distance from the outlet orifices 5a, 5b and the connecting edge 8 thus does not intersect the outlet orifices 5a, 5b. In this way, more reliable sealing of the outlet orifices 5a, 5b may be ensured, since material deformations in the region of the outlet orifices 5a, 5b resulting in particular from thermal stresses are more uniform and uneven deformation does not arise as a result of an abutting or connecting edge 8, which may lead subsequently to undesired sealing problems.

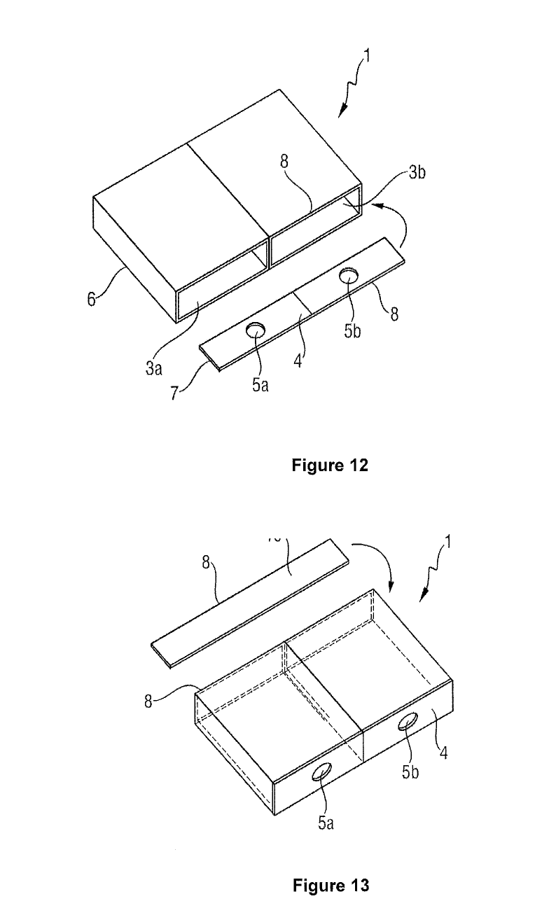

FIG. 12 shows a modification of the cartridge known from FIG. 10 and FIG. 11. In this embodiment the first cartridge element 6 takes the form of a single-part, cellular, bottom-less plastics container. The cartridge 1 is formed by fitting the bottom 4 to the container 6 along the connecting edge 8, which is indicated in the figure by the arrow. The bottom 4 comprises a first orifice 5a and a second orifice 5b, which, when the cartridge 1 is in the assembled state, allow preparation to flow out of the respective chambers 3a, 3b.

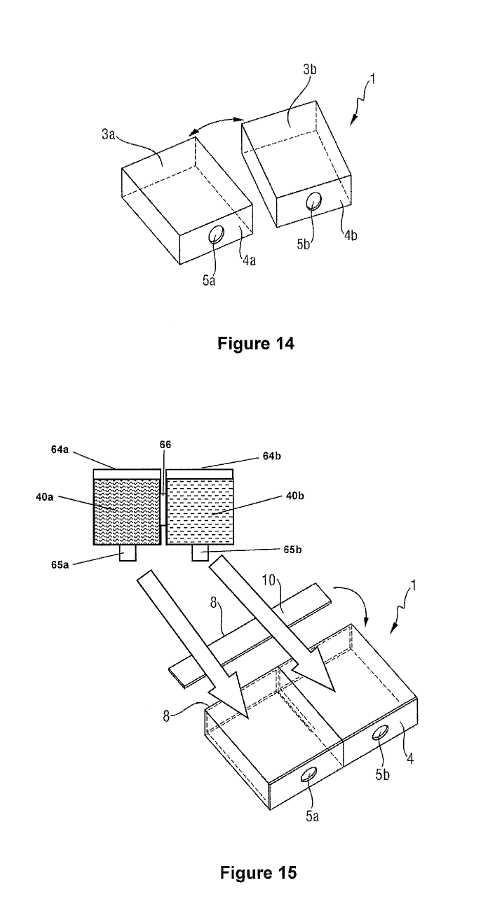

Alternatively, it is also conceivable for a cartridge element 6 to take the form of a cellular container open at the top, with the chambers 3a, 3b and the second element forming a cartridge lid 10, which is connected in liquid-tight manner to the cellular container open at the top along the connecting edge 8, as is clear from FIG. 13.

FIG. 14 shows that the cartridge 1 may also be formed of two separately formed chambers 3a, 3b. In this variant embodiment the two chambers 3a, 3b are connected detachably or nondetachably together interlockingly and/or frictionally and/or by material bonding, so forming the cartridge 1.

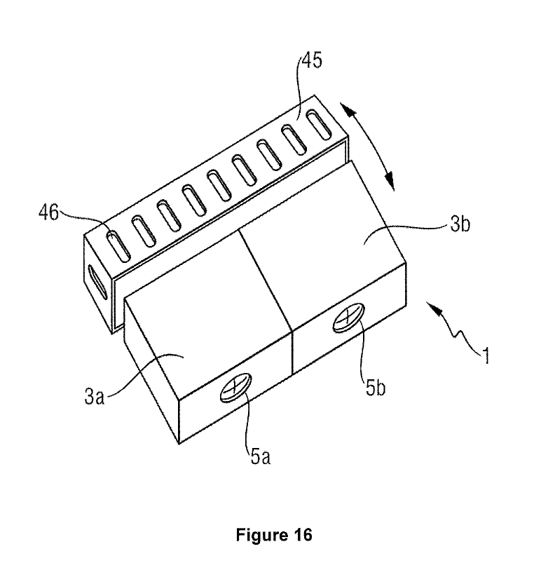

FIG. 15 shows the cartridge 1 known from FIG. 13 in the form of a receiving container for a pouch 64 filled with preparation 40, such that insertion of the pouches into the cartridge chambers, which is indicated by the arrows in the Figure, forms a “bag-in-bottle” container. The orifices 65a, 65b of the pouch 64a, 64b are designed such that they may be inserted into the orifices 5a, 5b in the cartridge 1. Preferably the orifices 65a, 65b take the form of dimensionally stable plastics cylinders. It is on the one hand conceivable for in each case one pouch 64a, 64b to be positioned in a corresponding chamber of the cartridge 1, but it is also possible to construct a multi-chamber pouch connected by way of a web 66, which multi-chamber pouch is inserted as a whole into the cartridge.

FIG. 16 shows a further development of the cartridges known from FIG. 10 to FIG. 14, in which a further chamber 45 for accommodating a preparation is arranged on the cartridge and is configured in such a way as to effect release of volatile substances from the preparation into the surrounding environment of the chamber 45.

Volatile scents or air freshening substances for example may be situated in the chamber 45 and released through the orifices 46 in the chamber 45 into the surrounding environment.

It will additionally be noted that the orifices 5a, 5b are closed by silicone valves which comprise an x-shaped slit.

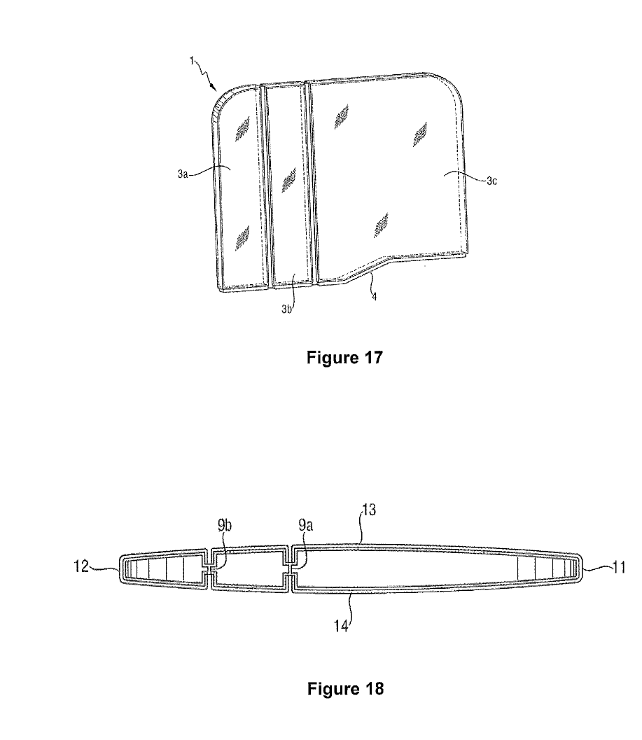

FIG. 17 shows a further possible embodiment of the cartridge 1 with three chambers 3a, 3b, 3c. The first chamber 3a and the second chamber 3b have approximately the same capacity. The third chamber 3c has a capacity which is for instance 5 times that of chamber 3a or 3b. The cartridge bottom 4 comprises a ramp-shaped step in the region of the third chamber 3c. This asymmetric configuration of the cartridge 1 makes it possible to ensure that the cartridge 1 is couplable to the dispenser 2 in a position intended therefor and insertion in an incorrect position is prevented by a corresponding configuration of the dispenser 2 or the bracket 54.

The plan view of the cartridge shown in FIG. 18 shows the separating webs 9a and 9b, which separate the chambers of the cartridge 1 from one another. The cartridge known from FIG. 17 and FIG. 18 may be formed in various ways.

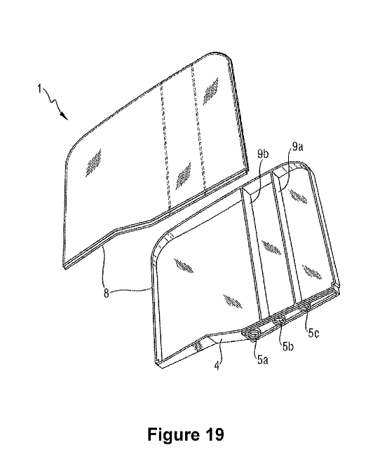

In a first variant, which may be inferred from FIG. 19, the cartridge 1 is formed of a first trough-like cartridge element 7 and a second, lid- or plate-like cartridge element 6. The separating webs 9a and 9b are provided in the trough-like cartridge element 7 and form the three chambers of the cartridge 1. On the bottom 4 of the trough-shaped cartridge element 7 the outlet orifices 5a, 5b, 5c are arranged in each case under the chambers of the cartridge 1.

As is additionally clear from FIG. 19, the bottom 4 of the cartridge in the region of the third chamber 3c comprises a ramp-like step, which forms a slope on the chamber bottom in the direction of the third outlet orifice 5c. In this way, it is ensured that preparation located in this chamber 3c is always conveyed in the direction of the outlet orifice 5c and thus good residual emptying characteristics of the chamber 3c are achieved.

When the cartridge 1 is assembled, the trough-shaped cartridge element 7 and the lid-like cartridge element 6 are bonded together along the common connecting edge 8. This may be achieved for example by welding or adhesive bonding. It goes without saying that, when the cartridge 1 is assembled, the webs 9a, 9b are also bonded to the cartridge element 6.

The connecting edge 8 does not here run through the outlet orifices 5a-c, so avoiding leakage problems in the region of the orifices 5a-c, in particular in the state coupled to the dispenser.

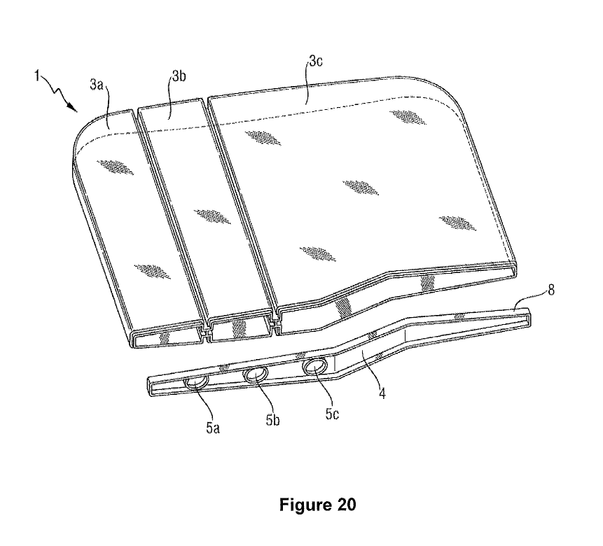

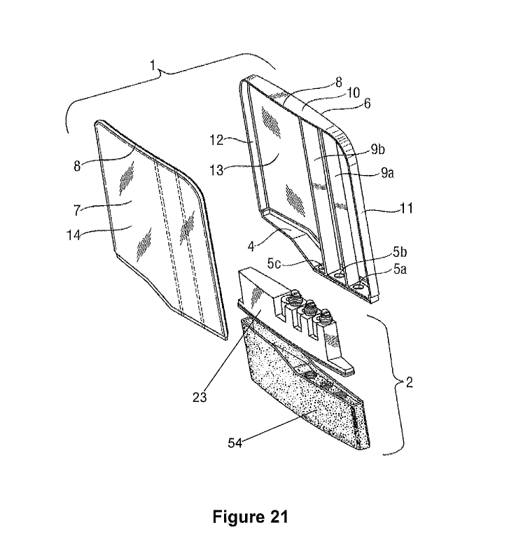

A further variant for embodying the cartridge is shown in FIG. 20. The first cartridge element 6 is here of cellular construction and comprises an open bottom. The separately formed bottom 4 may be inserted as a second cartridge element 7 into the orifice at the bottom of the cellular cartridge element 6 and bonded thereto along the common connecting edge 8. An advantage of this variant is that the cellular element 6 may be produced inexpensively by a plastics blow molding method.

FIG. 21 is an exploded representation of the essential components of the dispensing system consisting of cartridge 1 and dispenser 2.

As may be inferred from FIG. 21, the cartridge 1 is composed of two cartridge elements 6, 7, which are already known from FIG. 19. The dispenser 2 consists substantially of a component carrier 23 and a bracket 54, into which the component carrier 23 may be inserted.

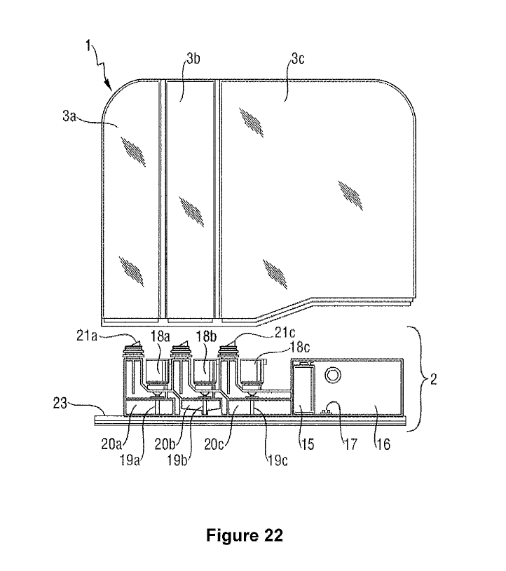

FIG. 22 shows a side view onto the component carrier 23 of the dispenser 2, which is explained in greater detail below.

The dispensing chamber 20, the actuator 18 and the closing element 19 are arranged on the component carrier 23, together with the energy source 15, the control unit 16 and the sensor unit 17. The dispensing chamber 20, the predispensing chamber 26, the dispensing chamber inlet 21 and the receptacle 29 are formed in a single part with the component carrier 23.

As may also be inferred from FIG. 22, the energy source 15, the control unit 16 and the sensor unit 17 are combined in an assembly by arranging them on a corresponding board.

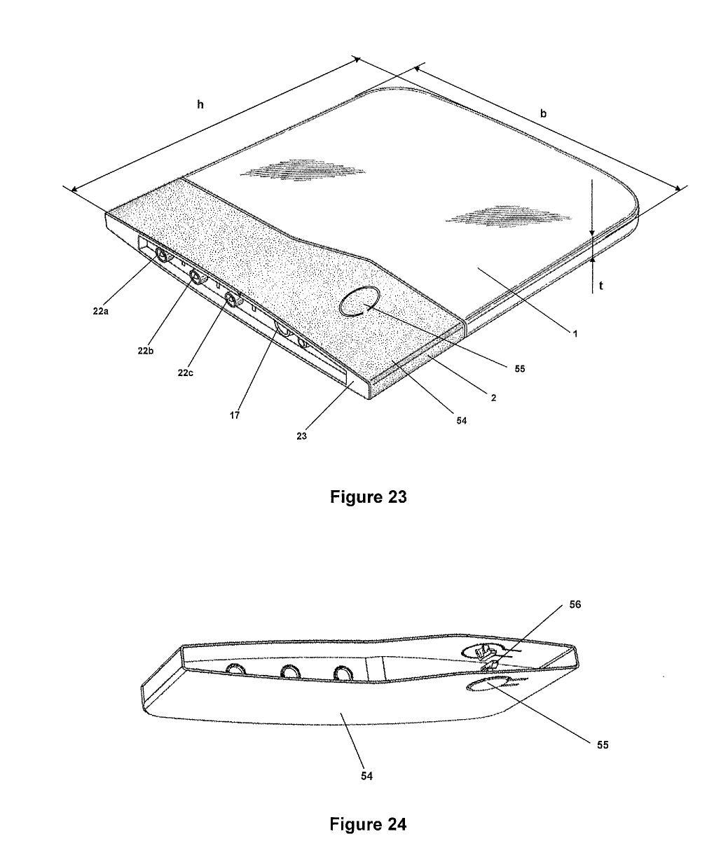

As shown in FIG. 23, the predispensing chamber 26 and the actuator 18 are arranged substantially next to one another on the component carrier 23. The predispensing chamber 26 has an L-shaped basic shape with a shoulder in the lower region, into which is set the receptacle 29 for the actuator 18. The outlet chamber 27 is arranged beneath the predispensing chamber 26 and the actuator 18. The predispensing chamber 26 and the outlet chamber 27 together form the dispensing chamber 20.

The predispensing chamber 26 and the outlet chamber 27 are connected together by the orifice 34.

The receptacle 29, the orifice 34 and the dispensing chamber outlet 22 lie in a row perpendicular to the longitudinal axis of the component carrier 23, such that the rod-shaped closing element 19 may be guided through the orifices 22, 29, 34.

FIG. 23 shows the dispenser 2 assembled with the cartridge 1 in perspective view. In the assembled state the dispensing system has a height h, a width b and a depth t. The width b and the height h should not exceed 210 mm. The depth t should amount to less than 20 mm. The width/height/depth ratio should amount to approximately 10:10:1. The height h and the width b preferably correspond to the dimensions of a medium-sized dinner plate. Thus, the dispensing system may be positioned simply, in a manner which is intuitive for the user, in the corresponding dish holder of a dishwasher washing basket.

FIG. 24 shows a perspective plan view of the bracket 54. It is apparent that a hook 56 is formed in each case inside on the hinge 55, which hook engages in a corresponding receptacle in the cartridge 1, so fixing the cartridge relative to the dispenser 2. The hooks 56 are situated substantially opposite one another. It is also conceivable for in total just one hook 56 to be arranged on the inside of the bracket 54.

As already mentioned above, the dispensing system of the above-described type is in principle suitable for use in or in conjunction with water-conveying devices of any type. As explained in the earlier exemplary embodiments, the dispensing system according to the invention is in particular suitable for use in water-conveying domestic appliances such as dishwashing and/or washing machines, but is not limited to such use. In general, it is possible to use the dispensing system according to the invention anywhere where dispensing of at least one, preferably a plurality of preparations into a liquid medium is required in accordance with an external physical or chemical parameter triggering or controlling a dispensing program.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A cartridge (1) for flowable washing or cleaning agents for use in a dispenser (2), comprising:
at least two elements (6,7), each having a connecting edge by which the at least two elements (6,7) are connected and bonded together to define an interior space;
a plurality of chambers (3a, 3b, 3c) within the interior space for spatially separate accommodation of different preparations of a flowable washing or cleaning agent;
a cartridge bottom surface (4) which in a service position is directed downwards in the direction of gravity; and
at least two chambers (3a, 3b, 3c), each of which comprises at least one outlet orifice (5a, 5b, 5c) arranged on the cartridge bottom (4),
wherein the connecting edge (8) of the elements (6, 7) extends across the cartridge bottom surface (4) at a distance from the outlet orifices (5a, 5b, 5c) such that the connecting edge (8) does not intersect with or come into contact with the outlet orifices (5a, 5b, 5c).

2. The cartridge according to claim 1, wherein the chambers (3a, 3b, 3c) are arranged substantially next to one another and the outlet orifices (5a, 5b, 5c) are arranged in a line.

3. The cartridge according to claim 1, wherein the ratio of height:width:depth of the cartridge (1) is between 10:10:1 and 50:50:1.

4. The cartridge according to claim 1, wherein the cartridge (1) further comprises a top surface (10) and side surfaces (11, 12), and the connecting edge (8) extends along the top (10), bottom (4) and side surfaces (11, 12) of the cartridge (1).

5. The cartridge according to claim 1, wherein one element (6) is trough-shaped and the second element (7) is lid-like.

6. The cartridge according to claim 1, wherein both elements (6, 7) are trough-shaped.

7. The cartridge according to claim 1, wherein at least one cartridge element (6, 7) comprises at least one separating web (9a, 9b), which, in the assembled state of the elements (6, 7), separates two adjacent chambers (3a, 3b, 3c) of the cartridge (1) from one another.

8. The cartridge according to claim 1, wherein one of the cartridge elements (6) takes the form of a bottomless cellular container with the chambers (3a, 3b, 3c) and the second cartridge element takes the form of a cartridge bottom (4), which is connected in liquid-tight manner to the bottomless cellular container along the connecting edge (8) or the second element takes the form of a cartridge lid (10), which is connected in liquid-tight manner to the cellular container open at the top along the connecting edge (8).

9. The cartridge according to claim 1, wherein the cartridge (1) comprises an asymmetric three-dimensional shape such that coupling with the dispenser (2) is possible only when the cartridge (1) and the dispenser (2) are in a position intended therefor.

10. The cartridge according to claim 1, further comprising ventilation means positioned toward the top of the cartridge for ventilation of the cartridge chambers (3a, 3b, 3c) to ensure pressure equalization between the interior of the cartridge chambers (3a, 3b, 3c) and the surrounding environment as the filling level of the chambers (3a, 3b, 3c) declines.

11. The cartridge according to claim 10, wherein the ventilation means is a valve.

12. The cartridge according to claim 11, wherein the valve is a silicone valve.

13. The cartridge according to claim 10, wherein the ventilation means comprises microorifices in a cartridge wall.

14. The cartridge according to claim 1, further comprising at least one ventilation orifice at the bottom surface in the direction of gravity for the ventilation of at least one chamber, wherein the ventilation orifice is separate from the release orifice and the ventilation orifice is connected in communicating manner with at least one chamber of the cartridge via a ventilation channel in such a way that the end of the ventilation channel remote from the ventilation orifice opens, in a release position of the cartridge as coupled with the dispenser, above the maximum filling level of the cartridge.

15. The cartridge according to claim 14, wherein the ventilation channel is formed wholly or partially, in particular integrally, in or on the walls and/or webs of the cartridge.

16. The cartridge according to claim 1, further comprising one ventilation orifice and one release orifice for each of the chambers.

17. The cartridge according to claim 1, wherein each of the outlet orifices (5a, 5b, 5c) has a diameter of 0.7-1.0 times a width of the cartridge bottom (4).

18. A dispensing system (1, 2), in particular for a user to position in the interior of a dishwashing machine, comprising;
at least one cartridge (1), as set forth in claim 1; and
a dispenser (2) couplable with the cartridge (1) and comprising;
at least one energy source (15),
a control unit (16),
a sensor unit (17),
at least one actuator (18), which is connected with the energy source (15) and the control unit (16) in such a manner that a control signal from the control unit (16) brings about movement of the actuator (18),
a closing element (19), which is coupled with the actuator (18) such that movement of the actuator (18) displaces the closing element (19) into a closure or a release position, and
at least one dispensing chamber (20) which, when cartridge (1) and dispenser (2) are assembled, is connected in communicating manner with at least one of the cartridge chambers (3a, 3b, 3c), the dispensing chamber (20) comprising an inlet (21) for inflow of washing or cleaning agent from a cartridge chamber (3a, 3b, 3c) and an outlet (22) for outflow of washing or cleaning agent from the dispensing chamber (20) into the surrounding environment, at least the outlet (22) of the dispensing chamber (20) being closable or openable by the closing element (19).
